(19) United States
(12) Patent Application Publication
(10) Pub. No.: US 2022/0198445 A1
(43) Pub. Date: Jun. 23, 2022

(54) REAL-TIME PREDICTION OF PARAMETER MODIFICATIONS BASED ON STRUCTURED MESSAGING DATA

(71) Applicant: The Toronto-Dominion Bank, Toronto (CA)

(72) Inventors: Christopher Mark JONES, Villanova, PA (US); Barry Wayne BAIRD, JR., Kennett Square, PA (US); Claude Bernell LAWRENCE, JR., Philadelphia, PA (US); Jonathan Joseph PRENDERGAST, West Chester, PA (US)

(21) Appl. No.: 17/550,913

(22) Filed: Dec. 14, 2021

Related U.S. Application Data
(60) Provisional application No. 63/128,039, filed on Dec. 19, 2020.

(51) Int. Cl. G06Q 20/38; G06Q 20/40; G06N 20/00

(52) U.S. Cl. CPC G06Q 20/386; G06N 20/00; G06Q 20/4015; G06Q 20/389

(57) ABSTRACT

The disclosed embodiments include computer-implemented apparatuses and processes that predict, in real-time modifications to parameters based on structured messaging data. For example, an apparatus obtains (i) first elements of decomposed message data that characterize real-time payments requested by a first counterparty and (ii) a second elements of decomposed message data that characterize real-time payments requested by one or more second counterparties associated with the first counterparty. The apparatus determines a first value of a parameter of a data exchange based on the first elements of decomposed message data, and determines a second value of the parameter based on the second elements of decomposed message data. Based on the first and second parameter values, the apparatus generates information characterizing a modification to at least the first parameter value during a temporal interval, and transmit notification data that includes the information characterizing the modification to a device operable by the first counterparty.

### CROSS-REFERENCE TO RELATED APPLICATION

This application claims the benefit of priority to U.S. Provisional Patent Application No. 63/128,039, filed on Dec. 19, 2020, the entire disclosure of which is expressly incorporated herein by reference to its entirety.

### TECHNICAL FIELD

The disclosed embodiments generally relate to computer-implemented systems and processes that predict, in real-time modifications to parameters based on structured messaging data.

### BACKGROUND

Today, the mass adoption of smart phones and digital payments within the global marketplace drives an increasingly rapid adoption of real-time payment (RTP) technologies by financial institutions, consumers, vendors and merchants, and other participants in the payment ecosystem. RTP technologies emphasize data, messaging, and global interoperability and in contrast to many payment rails, such as those that support credit card payments, embrace the near ubiquity of mobile technologies in daily life.

### SUMMARY

In some examples, an apparatus includes a communications interface, a memory storing instructions, and at least one processor coupled to the communications interface and to the memory. The at least one processor is configured to execute the instructions to obtain (i) first elements of decomposed message data that characterize real-time payments requested by a first counterparty and (ii) second elements of decomposed message data that characterize real-time payments requested by one or more second counterparties. Each of the one or more second counterparties is associated with the first counterparty. The at least one processor is configured to execute the instructions to determine a first value of a parameter of an exchange of data based on the first elements of decomposed message data, and determine a second value of the parameter based on the second elements of decomposed message data. The at least one processor is configured to execute the instructions to, based on the first and second parameter values, generate information characterizing a modification to at least the first parameter value during a temporal interval, and to transmit, via the communications interface, notification data that includes the information characterizing the modification to a device operable by the first counterparty. The notification data causes an application program executed at the device to present a graphical representation of the modification within a digital interface.

In other examples, a computer-implemented method includes, using at least one processor, obtaining (i) first elements of decomposed message data that characterize real-time payments requested by a first counterparty and (ii) a second elements of decomposed message data that characterize real-time payments requested by one or more second counterparties. Each of the one or more second counterparties being associated with the first counterparty. The computer-implemented method includes determining, using the at least one processor, a first value of a parameter of an exchange of data based on the first elements of decomposed message data, and determining, using the at least one processor, a second value of the parameter based on the second elements of decomposed message data. Further, the computer-implemented method includes based on the first and second parameter values, generating, using the at least one processor, information that characterizes a modification to at least the first parameter value during a temporal interval, and transmitting, using the at least one processor, notification data that includes the information characterizing the modification to a device operable by the first counterparts. The notification data causes an application program executed at the device to present a graphical representation of the modification within a digital interface.

Further, in some examples, a tangible, non-transitory computer-readable medium storing instructions that, when executed by at least one processor, may cause the at least one processor to perform a method, including, obtaining (i) first elements of decomposed message data that characterize real-time payments requested by a first counterparty and (ii) a second elements of decomposed message data that characterize real-time payments requested by one or more second counterparties. Each of the one or more second counterparties being associated with the first counterparty. The method includes determining a first value of a parameter of an exchange of data based on the first elements of decomposed message data, and determining a second value of the parameter based on the second elements of decomposed message data. Further, the method includes, based on the first and second parameter values, generating information that characterizes a modification to at least the first parameter value during a temporal interval, and transmitting notification data that includes the information characterizing the modification to a device operable by the first counterparts. The notification data causes an application program executed at the device to present a graphical representation of the modification within a digital interface.

The details of one or more exemplary embodiments of the subject matter described in this specification are set forth in the accompanying drawings and the description below. Other potential features, aspects, and advantages of the subject matter will become apparent from the description, the drawings, and the claims

### BRIEF DESCRIPTION OF THE DRAWINGS

FIG. 1 is a block diagram of an exemplary computing environment, in accordance with some exemplary embodiments.

FIGS. 2A, 2B, and 3A-3C block diagrams illustrating portions of an exemplary computing environment, in accordance with some exemplary embodiments.

FIG. 4 is a flowchart of exemplary process 400 for decomposing a request-for-payment (RFP) message formatted and structured in accordance with one or more standardized data-exchange protocols, in accordance with some exemplary embodiments.

FIG. 5 is a flowchart of an exemplary process 500 for predicting targeted modifications to customer-based metric values during future temporal intervals, in accordance with some exemplary embodiments.

Like reference numbers and designations in the various drawings indicate like elements.

### DETAILED DESCRIPTION

Today, small businesses, including micro-businesses and entrepreneurs participating in the “gig” economy, represent vibrant and essential components of the global economic system. Through their normal course of business, these small businesses often provide discrete services to customers within a defined temporal interval, and in exchange for these services, receive corresponding discrete payments in agreed-upon amounts. For example, a small business, such as a local landscaping company, may provide lawn care and mulching services to a particular community or geographic region at a predetermined hourly rate, upon completion of the lawn care and mulching services, customers may provide payments to the local landscaping company in accordance with the predetermined hourly rate. In other examples, the small business may include a driver that provides shared-ride services to customers in accordance with an agreed-upon fare, or a driver that delivers food to customers in accordance with an agreed-upon delivery fee. Upon completion of the shared-ride services, or upon completion of the deliveries, the customers may provide payments to the small business in accordance with the agreed-upon fare or the agreed-upon delivery fee.

For example, upon a successful provisioning of a corresponding product or service by a small business, a customer of a financial institution may provide the small business with data characterizing a payment instrument, such as credit card account issued by the financial institution (e.g., via input provisioned to the web page or digital portal, or based on an interrogation of a physical payment card by point-of-sale terminal, etc.). A computing system or device operated by the small business may perform operations that generate elements of messaging data that identify and characterize the small business and the initiated purchase transaction, and that include portions of the data characterizing the payment instrument, and that submit the generated elements of messaging data to a transaction processing network or payment rail in accordance with a predetermined schedule, e.g., in batch form with other elements of messaging data at a predetermined time on a daily basis. In some instances, one or more computing systems of the transaction processing network or payment rail may perform operations that execute, clear, and settle the initiated purchase transaction involving the payment instrument within a predetermined temporal interval subsequent to the initiation of the purchase transaction, such as, but not limited to, forty-eight hours.

The significant delay between an initiation of the payment transaction by the customer and not only a time at which the initiated transaction posts to an account of the small business at a financial institution, but also a time at which funds associated with the payment transaction become accessible to the customer, may render transaction processing networks or payment rails incapable of providing a small business with any real-time indication of a location-specific demand for the provisioned products or services, much less any data comparing the services provisioned by the small business, and the corresponding payment amounts, to other comparable small business operating proximate to the small business. Further, while certain mobile applications associated ride-share or food delivery services may alert both a customer and a small business to increases in aggregate demand during a particular temporal interval (e.g., “surge” pricing), these mobile applications are often incapable of providing any comparative analysis of a relationship between the current pricing or demand associated with the small-business customer, and are often unable to provide, in real-time, granular data indicative of a change in aggregated, location- or service-specific demand for provisioned services across multiple geographic regions.

In other examples, the small business and the customers may be represent participants in a real-time payment (RTP) ecosystem, and the computing system or device operated by the small business (or a computing system associated with a financial institution of the small business) may generate a message, e.g., a Request for Payment (RFP) message, that requests a real-time payment from the customer that funds the initiated purchase transaction, and may transmit that message to one or more computing systems of the financial institution of the customer, e.g., directly or through one or more intermediate systems associated with the RTP ecosystem, such as a clearinghouse system. The generated and transmitted RFP message may, for example, be formatted in accordance with the ISO 20022 data-exchange format, and may include message fields populated with information that includes, but is not limited to, information identifying the customer (e.g., a customer name) and the small business (e.g., an industrial classification code, such as a standard industrial classification (SIC) code assigned to the small business), information characterizing the requested payment (e.g., a requested payment amount, a requested payment date, an identifier of an account selected by the customer to fund the requested, real-time payment, or an identifier of an account of the merchant capable of receiving the requested, real-time payment, etc.) and information characterizing the initiated purchase transaction (e.g., a transaction date or time, or an identifier of one or more of the products or services involved in the initiated purchase transaction, such as a corresponding UPC, etc.). Further, the ISO-20022-compliant RFP message may also include a link within a structured or unstructured message field to information, such as remittance data, associated with the requested, real-time payment (e.g., a long- or shortened Uniform Resource Location (URL) pointing to a formatted invoice or statement that includes any of the information described herein).

In some examples, the elements of structured or unstructured data maintained within the message fields of exemplary, ISO-20022-compliant RFP messages described herein may extend beyond the often-limited content of the message data transmitted across many existing payment rails and transaction processing networks. Further, when intercepted and decomposed by a computing system of the financial institution of the customer (e.g., an FI computing system), these elements of decomposed message data processed by the FI computing system to perform operations that, among other things, characterize a current pricing for particular product or service provided by a small-business customer of the financial institution, comparative data that highlights the current pricing of the particular product or service offered by the small-business customer, and compares that current pricing with the pricing of, or aggregate demand, for the particular product or service across one or more comparable merchants or geographic locations during a current temporal interval and additionally, or alternatively, during one or more prior or future temporal intervals. Further, and through a provisioning of a notification to the computing system or device of the small business that characterizes the current pricing for the particular product or service and the comparative data, the small business may adjust, in real-time and during a future temporal interval, the pricing for the particular product or service in accordance with the current pricing for the particular product or service.

Certain of the exemplary processes described herein, which decompose the structured message fields of ISO-20022-compliant RFP messages to obtain corresponding elements of decomposed message data characterizing the customer, the small business, the initiated purchase transaction, and the requested, real-time payment, which analyze the elements of decomposed message data to determine a current pricing for a particular product or service provided by a small business and to compare that current pricing of, or aggregate demand, for the particular product or service across one or more comparable merchants or geographic locations during a current temporal interval, and which providing data characterizing the current pricing for the particular product or service and the comparison across the one or more comparable merchants or geographic locations to the computing system or device of the small business, may enable the small business to dynamically adjust the current pricing of the particular product or service in real time and in accordance with the comparison. One or more of these exemplary processes may be implemented by the computing system of the financial institution in addition to, or as an alternate to, many processes that relay on the often-limited content of temporally delayed message data transmitted across many existing payment rails and transaction processing networks.

### A. Exemplary Computing Environments

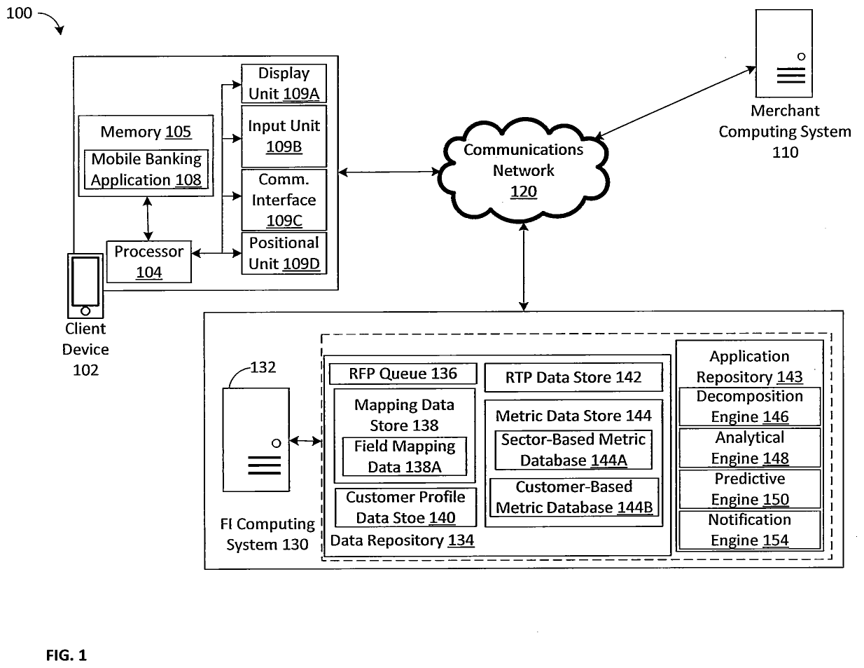

FIG. 1 is a diagram illustrating an exemplary computing environment 100 that includes, among other things, one or more computing devices, such as a client device 102, and one or more computing systems, such as a financial institution (FI) system 130, each of which may be operatively connected to, and interconnected across, one or more communications networks, such as communications network 120. Examples of communications network 120 include, but are not limited to, a wireless local area network (LAN) (e.g., a “Wi-Fi” network), a network utilizing radio-frequency (RF) communication protocols, a Near Field Communication (NFC) network, a wireless Metropolitan Area Network (MAN) connecting multiple wireless LANs, and a wide area network (WAN) (e.g., the Internet).

Client device 102 may include a computing device having one or more tangible, non-transitory memories, such as memory 105, that store data and/or software instructions, and one or more processors, such as, processor 104, configured to execute the software instructions. The one or more tangible, non-transitory memories may, in some aspects, store software applications, application modules, and other elements of code executable by the one or more processors, such as, but not limited to, an executable web browser (e.g., Google Chrome™, Apple Safari™, etc.), and additionally or alternatively, an executable application associated with FI computing system 130 (e.g., mobile banking application 108). In some instances, not illustrated in FIG. 1, memory 105 may also include one or more structured or unstructured data repositories or databases, and client device 102 may maintain one or more elements of device data and location data within the one or more structured or unstructured data repositories or databases. For example, the elements of device data may uniquely identify client device 102 within computing environment 100, and may include, but are not limited to, an Internet Protocol (IP) address assigned to client device 102 or a media access control (MAC) layer assigned to client device 102.

Client device 102 may also include a display unit 109A configured to present interface elements to a corresponding user and an input unit 109B configured to receive input from the user. For example, input unit 109B configured to receive input from the user in response to the interface elements presented through display unit 109A. By way of example, display unit 109A may include, but is not limited to, an LCD display unit or other appropriate type of display unit, and input unit 109B may include, but is not limited to, a keypad, keyboard, touchscreen, voice activated control technologies, or appropriate type of input unit. Further, in additional aspects (not illustrated in FIG. 1), the functionalities of display unit 109A and input unit 109B may be combined into a single device, such as, a pressure-sensitive touchscreen display unit that presents interface elements and receives input from the user of client device 102. Client device 102 may also include a communications interface 109C, such as a wireless transceiver device, coupled to processor 104 and configured by processor 104 to establish and maintain communications with communications network 120 via one or more communication protocols, such as WiFi®, Bluetooth®, NFC, a cellular communications protocol (e.g., LTE®, CDMA®, GSM®, etc.), or any other suitable communications protocol.

Further, and as described herein, client device 102 may include a positional unit 109D coupled to processor 104 and configured by processor 104 to determine a geographic location of client device 102 (e.g., a longitude, latitude, altitude, etc.) at regular temporal intervals, and to store data indicative of the determined geographic location within a portion of corresponding tangible, non-transitory memory (e.g., as one or more of the elements of location data described herein), along with data identifying the temporal interval (e.g., a time stamp specifying a corresponding time and/or date). Examples of positional unit 109D include, but are not limited to, an on-board Global Positioning System (GPS) receiver, an on-board assisted GPS (A-GPS) receiver, or a positioning unit consistent with other positioning systems.

Examples of client device 102 may include, but not limited to, a personal computer, a laptop computer, a tablet computer, a notebook computer, a hand-held computer, a personal digital assistant, a portable navigation device, a mobile phone, a smart phone, a wearable computing device (e.g., a smart watch, a wearable activity monitor, wearable smart jewelry, and glasses and other optical devices that include optical head-mounted displays (OHMDs), an embedded computing device (e.g., in communication with a smart textile or electronic fabric), and any other type of computing device that may be configured to store data and software instructions, execute software instructions to perform operations, and/or display information on an interface device or unit, such as display unit 109A. In some instances, client device 102 may also establish communications with one or more additional computing systems or devices operating within computing environment 100 across a wired or wireless communications channel (via the communications interface 109C using any appropriate communications protocol). Further, a user, such as user 101, may operate client device 102 and may do so to cause client device 102 to perform one or more exemplary processes described herein.

FI computing system 130 and merchant computing system 110 may each represent a computing system that includes one or more servers and one or more tangible, non-transitory memory devices storing executable code, application engines, or application modules. Each of the one or more servers may include one or more processors, which may be configured to execute portions of the stored code, application engines, or application modules to perform operations consistent with the disclosed exemplary embodiments. For example, as illustrated in FIG. 1, FI computing system 130 may include one or more servers 132 having one or more processors configured to execute portions of the stored code, application engines or modules, or additional elements of executable code maintained within the one or more corresponding, tangible, non-transitory memories. In some instances, FI computing system 130 and merchant computing system 110 may each correspond to a discrete computing system, although in other instances, FI computing system 130 or merchant computing system 110 may correspond to a distributed computing system having multiple, computing components distributed across an appropriate computing network, such as communications network 120 of FIG. 1, or those established and maintained by one or more cloud-based providers, such as Microsoft Azure™, Amazon Web Services™, or another third-party, cloud-services provider. Further, FI computing system 130 and merchant computing system 110 may each include one or more communications units, devices, or interfaces, such as one or more wireless transceivers, coupled to the one or more processors for accommodating wired or wireless internet communication across communications network 120 with other computing systems and devices operating within computing environment 100 (not illustrated in FIG. 1).

As described herein, merchant computing system 110 may be associated with, or operated by, a merchant that offers product and services for sale to corresponding customers, and FI computing system 130 may be associated with, or operated by, a financial institution that offers financial products or services to one or more individual or small-business customers, such as user 101. The financial products may, for example, include a payment instrument issued to a customer by the financial institution and available to fund one or more initiated payment or purchase transactions. Examples of the payment instrument may include, but are not limited to, a credit card account issued by the financial institution or a checking, savings, or other deposit account issued by and maintained at the financial institution. Further, the financial products may also include one or more deposit accounts, such as the checking or savings accounts described herein, issued to corresponding customers and available to receive proceeds from one or more payment or purchase transactions.

In some instances, FI computing system 130 may perform any of the exemplary processes described herein to generate, obtain, receive, or intercept a plurality of request-for-payment (RFP) messages involving corresponding customers of the financial institution. Each of the RFP messages may be associated with corresponding payments requested, in real-time, by or from a customer of the financial institution (e.g., user 101 associated with client device 102, and the real-time payment identified and characterized by each of the RFP messages may be associated with a purchase transaction involving a corresponding product or service, initiated between the customer and a counterparty. By way of example, for a particular one of the RFP messages, the corresponding customer may represent a small-business customer of the financial institution that offers the corresponding product or service for sale to the counterparty, and the particular RFP message, which may be generated by FI computing system 130, may enable the corresponding customer to request the real-time payment for the corresponding product or service from the counterparty. In some instances, FI computing system 130 may perform operations that broadcast the particular RFP message across communications network 120 to a computing system of the counterparty's financial institution, either directly or through one or more intermediate computing systems, such as a computing system of a clearinghouse associated with the RTP ecosystem.

In other examples, for a particular one of the RFP messages, the counterparty may represent a merchant that offers the corresponding products for services for sale to the corresponding customer, and the particular RFP message may enable the counterparty to obtain payment in real-time for the purchase products or services. As described herein, FI computing system 130 may perform any of the exemplary processes described herein to receive the particular RFP message directly from the computing system of the counterparty's financial institution, or from one of the intermediate computing systems, such as the clearinghouse computing system. FI computing system 130 may also perform operations that store each of the RFP messages within a message queue, such as RFP queue 136, established for a corresponding one of the customers of the financial institution.

As described herein, the RFP message may be formatted and structured in accordance with one or more standardized data-exchange protocols, such as the ISO 20022 standard for electronic data exchange between financial institutions. Additionally, the message fields of the RFP message may include discrete elements of structured or unstructured data that identify and characterize the initiated purchase transaction, the available payment instrument, and the counterparties to the initiated purchase transaction (e.g., the customer and the merchant). For example, the message fields of the RFP message may include, but are not limited to structured elements of customer data that identify a corresponding one of customers of the financial institution (e.g., a name of the customer, a unique alphanumeric identifier assigned to the customer, a postal address, standard industrial classification (SIC) code, etc.), such as, not limited to, the small-business customers of the financial institution described herein. Additionally, the message fields of the RFP message may include structured elements of vendor data that identify the merchant or vendor (e.g., a merchant or vendor name, a standard industrial classification (SIC) code characterizing the vendor or merchant, etc.) and one or more portions of a postal address associated with the merchant or vendor.

The message fields of the RFP message may also include, structured elements of transaction data that characterize the corresponding purchase transaction (e.g., a total transaction amount, a pre-tax transaction amount, a transaction time or date, identifiers of the purchased products or services, etc.) and structured elements of payment data characterizing the requested real-time payment (e.g., payment amount, a requested payment date, etc.). The structured elements of payment data may, for example, identify and characterize the payment instrument that funds the initiated purchase transaction (e.g., a payment method, a requested payment account, identifiers of a source account and a destination account associated with a requested transfer of funds, etc.). Further, in some examples, the message fields of the RFP message may also include a link within a structured or unstructured message field to information associated with the initiated purchase transaction (e.g., a link to a PDF or HTML receipt for the purchase transaction). Additionally, the information populating the message fields of the ISO-20022-compliant RFP messages may, for example, extend beyond the data incorporated within payment messages transmitted across existing payment rails (e.g., through existing electronic bill payment technologies).

In some instances, FI computing system 130 may perform any of the exemplary processes described herein to determine, in real-time, a pricing of, or an aggregate demand for, certain products or services across various merchant categories or geographic region during a current temporal interval, and additionally or alternatively, during future temporal intervals. FI computing system 130 may also perform any of the exemplary processes described herein to determine a current pricing for a particular product or service provided by a small-business customer of the financial institution (e.g., an average value of transaction involving the small-business customer during the current business day, etc.) and further, to generate comparative data that highlights the current pricing of the particular product or service offered by the small-business customer. As described herein, the comparative data may include information pertaining to a comparison between the current pricing with the pricing of, or aggregate demand, for the particular product or service across one or more comparable merchants or geographic locations during a current temporal interval and additionally, or alternatively, during one or more prior or future temporal intervals. Additionally, FI computing system 130 may generate notification data based on the comparison data, and transmit across communications network 120 to client device 102.

To facilitate a performance of one or more of these exemplary processes, FI computing system 130 may maintain, within the one or more tangible, non-transitory memories, a data repository 134 that includes, but is not limited to, a request-for-payment (RFP) message queue 136, a mapping data store 138, a customer profile data store 140, a RTP data store 142, and a metric data store 144. RFP queue 136 may include one or more discrete RFP messages received by FI computing system 130 using any of the exemplary processes described herein.

Mapping data store 138 may include structured or unstructured data records that maintain one or more elements of field mapping data 138A. For example, and as described herein, FI computing system 130 may generate, receive, obtain, or intercept one or more RFP messages, each of which may be formatted and structured in accordance with a corresponding, standardized data-exchange protocol, such as the ISO 20022 standard for electronic data exchange between financial institutions. In some instances, the one or more elements of field mapping data 138A may characterize a structure, composition, or format of the message data populating one or more data fields of the ISO-20002-compliant RFP message, or a corresponding RFP message compliant with an additional, or alternate, standardized data-exchange protocol.

Customer profile data store 140 may include structured or unstructured data records that maintain information identifying and characterizing one or more individual or small-business customers of the financial institution, and further, interactions between these customers and not only the financial institution, but also other unrelated third parties, such as the merchants or retailers described herein. By way of example, and for a corresponding one of the small-business customers of the financial institution, the data records of customer profile data store 140 may include a name of the customer, a unique alphanumeric identifier assigned to the customer, a postal address, data classifying an industry in which the small-business customer operates (e.g., a standard industrial classification (SIC), etc.) Additionally, and for the corresponding one of the small-business customers, the data records of customer profile data store 140 may also include profile information characterizing one or more financial goals associated with the small-business customer.

The data records of customer profile data store 140 may also include, for one or more of the customers of the financial institution, elements of account data identify and characterize a status of one or more account issued by the financial institution (e.g., balances, length of account existence, activity), elements of transaction data identifying and characterizing prior payment or purchase transactions involving corresponding ones of these customers. In some instances, portions of the information maintained within the data records customer profile data store 140 be extracted or derived from the message fields of received, obtained or intercepted RFP messages, e.g., in accordance with field mapping data 138A.

RTP data store 142 may include one or more elements of decomposed field data generated through a decomposition of corresponding ones of the received RFP messages, e.g., based on the elements of field mapping data 138A and through an implementation of any of the exemplary processes described herein. In some instances, the elements of decomposed field data maintained within RTP data store 142 may establish a time-evolving record of real-time payment transactions initiated by, or involving, the individual and small-business customers during a current temporal interval and across one or more prior temporal intervals, and across various merchant classifications or geographic region.

Metric data store 144 may include structured and unstructured data records that establish a sector-based metric database 144A and a customer-based metric database 144B. As described herein, sector-based metric database 144A may include sector-based metric values indicative of pricing of, or a demand for, one or more products or services offered by merchants or retailers associated with corresponding industrial classification codes (e.g., the SICs described herein) during a current temporal interval, and additionally or alternatively, during one or more prior temporal intervals. The sector-based metric values may, for example, include an average transaction value (e.g., as represented by a requested payment amount) during the current or prior temporal intervals and in some instances, more granular assessments of pricing and demand during the current or prior temporal intervals, such as, but not limited to, an average transaction value for certain products or services (e.g., average hourly costs for landscaping a lawn, average fees for shared rides via a corresponding ride-share service, average fees for delivering food via a food delivery service, etc.), an average transaction value within certain geographic regions (e.g., ZIP code 20007 within Washington, D.C.), or combinations thereof (average unit fees for delivering food in ZIP code 20007). Further, the current or prior temporal intervals may, for example, include an hour of a current business day, the current business day, or a current business week, month, or quarter, and a magnitude of the current or prior temporal intervals may across the corresponding industrial classification codes.

Further, customer-based metric database 139 may include structured or unstructured data records that maintain customer-based metric values indicative of a current pricing of, or a demand for, products or services offered for sale by one or more small-business customers of the financial institution, such as user 101. The customer-based metric values may, for example, include an average transaction value (e.g., as represented by a requested payment amount) during a current temporal interval, as described herein. The customer-based metric values may also include more granular assessments of pricing and demand during the current temporal interval, and may include an average transaction value for certain products or services (e.g., hourly costs for landscaping a lawn, average fees for shared rides via a ride chare service, average fees for delivering food via food-delivery service, etc.), an average transaction value within certain geographic regions (e.g., ZIP code 20007 within Washington, D.C.), or combinations thereof (average unit fees for delivering food in ZIP code 20007).

Further, and to facilitate the performance of any of the exemplary processes described herein, FI computing system 130 may also maintain, within the one or more tangible, non-transitory memories, an application repository 143 that maintains, but is not limited to, a decomposition engine 146, analytical engine 148, predictive engine 150, and notification engine 152, each of which may be executed by the one or more processors of FI computing system 130.

For example, and upon execution by the one or more processors of FI computing system 130, executed decomposition engine 146 may perform any of the exemplary processes described herein to obtain field mapping data 138A from mapping data store 138, to apply field mapping data 138A to a received, obtained, or intercepted RFP message. Additionally, executed decomposition engine 146 may perform any of the exemplary processes described herein to decompose the RFP message and obtain discrete elements of message data based on the application of field mapping data 138A to the RFP message. Examples of the discrete elements of message data, include among other things, elements that identify and characterize the customer (e.g., customer data), the corresponding ones of the vendors (e.g., vendor data), the corresponding ones of the purchase transactions (e.g., transaction data), and additionally, or alternatively, the requested payment (e.g., payment data). As described herein executed decomposition engine 146 may store decomposed field data that includes the extracted, obtained, or derived elements of customer data, payment data, and vendor data within a portion of a locally accessible data repository, such as within RTP data store 142., either alone or with information associated with a corresponding one of the RFP messages.

In some instances, based on the field mapping data 138A, executed decomposition engine 146 performs operations that decompose each of the one or more RFP messages, and that extract, obtain, or derive elements of customer data, payment data, and vendor data that characterize the corresponding purchase transaction and the corresponding real-time payment from the message fields of each of the decomposed RFP messages. These operations may include at least one of: (i) extracting elements of the customer data, payment data, and/or vendor data from one or more of the message fields of each of the decomposed RFP messages; (ii) accessing a link to remittance data within one of the message fields of at least one of the decomposed RFP messages, and parsing the link to extract at least one of the elements of the customer data, payment data, and vendor data; or (iii) obtaining the remittance data associated with the accessed link, and parsing the obtained remittance data to extract at least one of the elements of the customer data, payment data, and vendor data.

In Further, and upon execution by the one or more processors of FI computing system 130, executed analytical engine 148 may perform any of the exemplary processes described herein to determine and generate sector-based metric values. For example, the executed analytical engine 148 may parse the vendor data associated with each of the decomposed RFP messages and maintained by RTP data store 142 within corresponding elements of decomposed field data. Additionally, the executed analytical engine 148 may identify an industrial classification code, such as an SIC code, associated with each of the elements of decomposed field data within RTP data store 142, and as such, with the merchant associated with corresponding ones of the decomposed RFP messages. As described herein, the SIC code of a particular merchant may be indicative of an industry in which the particular merchant operates based on its underlying business activities.

Moreover, analytical engine 148 may perform operations that sort each of elements of decomposed field data within RTP data store 142 (and the corresponding elements of customer, payment, transaction, and vendor data) in accordance with the identified SIC codes. For instance, analytical engine 148 may group together elements of vendor data 136B, and associated elements of customer data 141A and payment data 141B, that are associated with a common SIC code (e.g., SIC codes associated with lawn care or landscaping, ride-share services, or food-food delivery services). Moreover, for each of the identified SIC codes, the analytical engine 148 may process the corresponding elements of customer data 141A and payment data 141B to compute sector-based metric values. Additionally, analytical engine 148 may store the sector-based metric values within sector-based metric database 139. In various examples, analytical engine 148 may store the sector-based metric values within sector-based metric database 139 in conjunction with metadata tags identifying the customer identifier, the corresponding SIC code, the current temporal interval, associated product or service, and/or associated geographic region.

Further, and upon execution by the one or more processors of FI computing system 130, executed analytical engine 148 may perform any of the exemplary processes described herein to determine and generate customer-based metric values, and perform comparative pricing and demand analysis, for corresponding ones of the small-business customers of the financial institution. For example, the executed analytical engine 148 may access customer profile data store 140, which includes, among other things, profile information identifying customers of the financial institution, and may obtain a customer identifier (e.g., a customer name, an alphanumeric login credential, etc.) of a selected small-business customer of the financial institution. Executed analytical engine 148 may perform operations that identify a subset of the elements of decomposed field data maintained within RTP data store 142 (that include corresponding elements of the customer, vendor, payment, and transaction described herein) that include or reference the customer identifier of the selected small-business customer, and determine an industrial classification code, e.g., a SIC code, associated with the selected small-business customer. Executed analytical engine 148 may process the corresponding elements of customer, payment, and transaction data maintained within the identified subset of the elements of decomposed field data, and may determine and generate corresponding ones of the customer-based metric values indicative of a current pricing of, or a demand for, the products or services offered for sale by the selected small-business customer. Executed analytical engine 148 may store the customer-based metric values within the customer-based metric database 144B, e.g., in conjunction with metadata tags identifying the customer identifier, the SIC code, a current temporal interval, associated product or service, and/or associated geographic region.

In some instances, executed analytical engine 148 may select the small-business customer in response to an express request provisioned by a computing system or device of the small-business customer (e.g., as generated by mobile banking application 108 executed at client device 102, etc.). In other instances, executed analytical engine 148 may select the small-business customer in response to an analysis of one or more financial goals associated with the small-business customer (e.g., as maintained within the data records of customer profile data store 140 associated with the customer identifier). Examples of these financial goals may, for example, include saving a certain amount of funds during a temporal interval to cover an expected or unexpected work-related expense (e.g., unexpected vehicle maintenance, anticipated payments for new equipment, etc.) or unexpected or expected expenses unrelated to work (e.g., a planned family vacation or business travel, a family event, etc.).

As described herein, executed analytical engine 148 may perform operations that obtain a SIC code from vendor data maintained within one or more elements of decomposed field data (e.g., within RTP data store 142), and that compute the sector-based metric values based on corresponding elements of decomposed field data sorted in accordance with the obtained SIC codes. In other examples, executed analytical engine 148 may also perform any of the exemplary processes described herein to obtain a SIC code from customer data maintained within one or more of the elements of decomposed field data (e.g., that are associated with corresponding RFP messages requested real-time payment from a small-business customer, etc.), and that further sort the elements of decomposed field data maintained within RTP data store 142 based on the SIC codes obtained from corresponding potion of the vendor or the customer data, and that compute the sector-based metric values based on the sorted elements of the decomposed field data. Further, the disclosed embodiments are not limited to the exemplary SIC codes described herein, and in other examples, executed analytical engine 148 may perform operations that sort the elements of decomposed field data based on any additional or alternate industrial classification code that would be appropriate to the customers of the financial institution and the corresponding RFP message, such as, but not limited to, a merchant classification code (MCC), a North American Industry Classification System (NAICS), or one or more identifiers of the provisioned products or services.

Additionally, upon execution by the one or more processors of FI computing system 130, executed predictive engine 150 may perform any of the exemplary processes described herein to determine and generate elements of inference data characterizing one or more inferences associated with the pricing or demand for the products or services offered for sale by the selected small-business customer. For example, executed predictive engine 150 may perform any of the exemplary processes describe herein to analyze the customer-based metric values during the current temporal interval and the sector-based metric values during the current or prior temporal intervals, and based on the analysis, to generate inference data characterizing inferences associated with the pricing or demand for the products or services offered for sale by the selected small-business customer. In some instances, executed predictive engine 150 may determine the one or more inferences by applying one or more internal rules to the customer-based metric values and sector-based metric values, or based on an application of a trained machine learning or artificial intelligence model to portions of the customer-based metric values and sector-based metric values during the current or prior temporal intervals.

In some implementations, a performance of one or more of the exemplary processes describe herein by executed predictive engine 150, which generate the elements of inference data, may be triggered by or may be based on one or more financial or budgeting goals associated with the selected small-business customer (e.g., as specified within data records of customer profile data store 140 associated with the corresponding customer identifier). For example, the accessed profile information may indicate that the selected small-business customer (e.g., a local landscaping company, as described herein) plans to acquire new landscaping equipment associated with a $500 initial outlay of funds. In some instances, the one or more determined inferences may indicate that landscaping company should increase its hourly fees, which current lag 20% behind competitor landscaping companies, by at least 15% to capitalize on the increased demand and to fund the expected expenditure. Executed predictive engine 150 may also perform operations, described herein, generate inference data that identifies the landscaping company's financial goals and the recommended 15% increase in hourly fees to accommodate the financial goals.

Upon execution by the one or more processors of FI computing system 130 executed notification engine 152 may perform any of the exemplary processes described herein to generate elements of notification data. The notification data may, for example, include one or more of the customer-based metric values during the current temporal intervals, one or more of the sector-based metric values during the current or prior temporal intervals, and all, or a selected portion of the inference data. Additionally, executed notification engine 152 may transmit the generated notification data to a device operable by the small-business customer, such as client device 102. As described herein, client device 102 may receive the notification data, and one or more application programs executed by the device, such as a mobile banking application 108, may present all or a selected portion of the notification data to the small-business customer within a digital interface, e.g., as a notification. For example, the notification may represent a “push” notification that, when presented by the executed mobile banking application 108, obscures all, or a portion, of a display screen presented within a digital interface of the mobile banking application 108 executed by client device 102. In other examples, the executed mobile banking application 108 may present the notification within a lock screen, a notification center, or a home screen of an operating system executed by client device 102 (e.g., as a banner or a pop-up). Additionally, in some examples, the presentation of the notification by the executed mobile banking application 108 may also trigger a presentation of an additional audible notification (e.g., a particular sound or element of digital music associated with the mobile banking application 108) and/or a tactile notification (e.g., vibration, etc.).

Further, although not illustrated in FIG. 1, the small-business customer may be associated with an autonomous vehicle, such as a self-driving car or an autonomous delivery robot, that includes one or more processors and a communications interface, such as a wireless transceiver, coupled to the one or more processors. By way of example, the one or more processors of the autonomous vehicle may be configured by executed instructions to establish communications across communications network 120 with one or more components of computing environment 100, such as FI computing system 130. In some instances, and in addition to the transmission of the notification data to the client device 102 of the small-business customer, executed notification engine 152 may also generate and transmit a further notification to the autonomous vehicle, which upon receipt and processing by the one or more processors, triggers an operation of the autonomous vehicle.

B. Computer-Implemented Processes for Determining One or More Inferences Associated with the Prince or Demand for the Products or Services of a Selected Small Business Customer

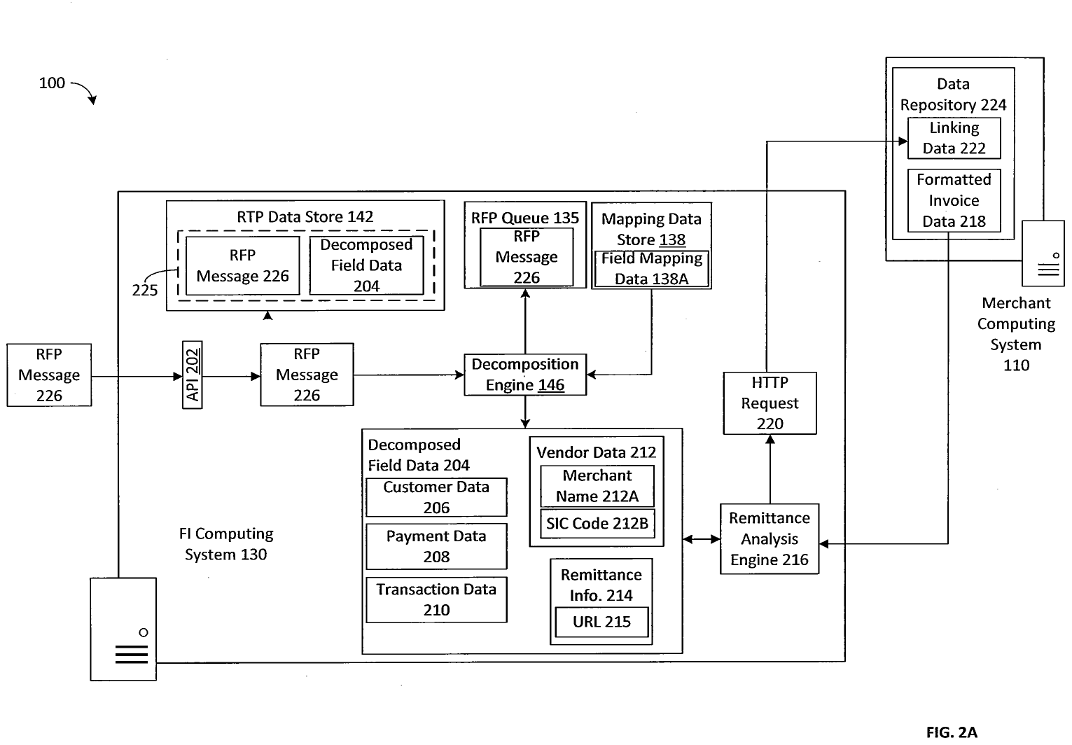

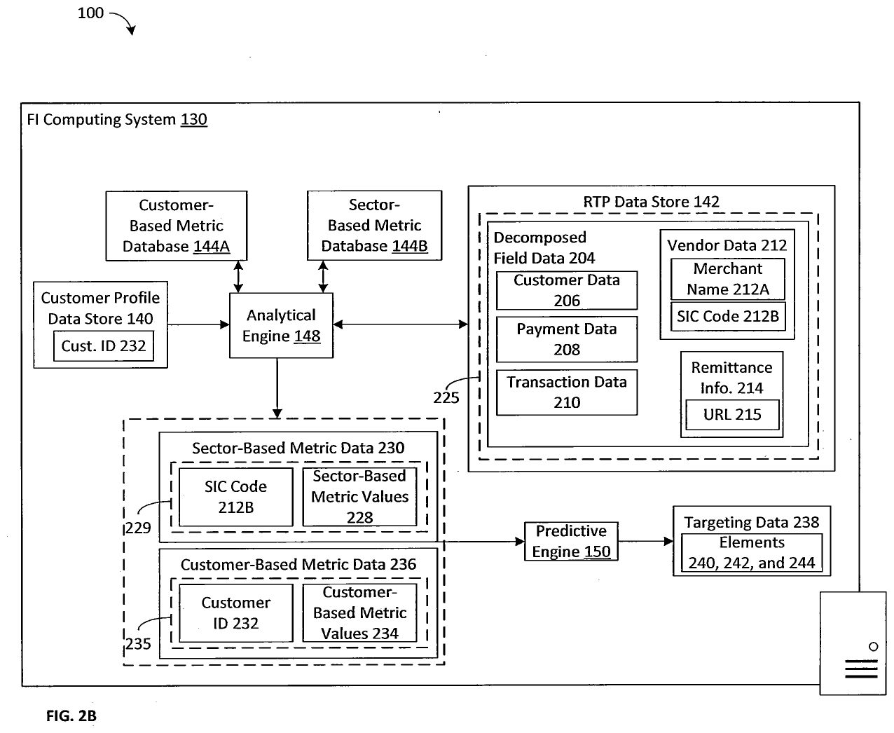

Referring to FIG. 2A, a computing system associated with the financial institution, such as the FI computing system 130, may obtain, generate, receive or a plurality of RFP messages identifying and characterizing real-time payment requested by, or requested from, customers of the financial institution, such as, but not limited to, RFP message 226. In some instances, RFP message 226 may identify and characterize a real-time payment requested from a small-business customer of the financial institution, such as user 101, from a corresponding merchant for an initiated purchase transaction involving corresponding products or services, and FI computing system of the financial institution may receive RFP message 226 from a merchant computing system 110, or from one or more intermediate computing system associated with the RTP ecosystem, such as, but not limited to, a computing system of a clearinghouse. As described herein, RFP message 226 may be structured in accordance with the ISO 20022 standard for electronic data exchange between financial institutions, and in some examples, RFP message 226 may correspond to a pain.013 message as specified within the ISO 20022 standard.

A programmatic interface established and maintained by FI computing system 130, such as application programming interface (API) 202, may receive RFP message 226, and may route RFP message 226 to a decomposition engine 146 executed by the one or more processors of FI computing system 130. In some examples, FI computing system 130 may receive RFP message 226 directly across communications network 120 via a channel of communications established programmatically between API 202 and an executed RTP engine of merchant computing system 110. Further, in some examples, one or more portions of RFP message 226 may be encrypted (e.g., using a public cryptographic key associated with FI computing system 130), and executed decomposition engine 146 may perform operations that access a corresponding decryption key maintaining within the one or more tangible, non-transitory memories of FI computing system 130 (e.g., a private cryptographic key associated with FI computing system 130), and that decrypt the encrypted portions of RFP message 226 using the corresponding decryption key.

In some instances, executed decomposition engine 146 may store RFP message 226 (in decrypted form) within a corresponding portion of data repository 134, e.g., within RFP queue 136. Executed decomposition engine 146 may also perform operations that access mapping data store 138 (e.g., as maintained within data repository 134), and obtain one or more elements of field mapping data 138A that characterize a structure, composition, or format of one or more data fields of RFP message 226. For example, and as described herein, RFP message 226 may include message fields consistent with the ISO 20022 standard for electronic data exchange between financial institutions, and each of the message fields may be populated with data structured and formatted in accordance with the ISO 20022 standard.

Based on the obtained elements of field mapping data 138A, executed decomposition engine 146 may perform operations that parse RFP message 226 and obtain elements of decomposed field data 204 that identify and characterize the customer (e.g., user 101 of client device 102), the counterparty (e.g., the merchant), the requested, real-time payment, and the initiated purchase transaction. In some instances, and through the performance of these exemplary operations, executed decomposition engine 146 may “decompose” the structured or unstructured data populating the message fields of RFP message 226 in accordance with field mapping data 138A, and generate the elements of decomposed field data 204 that include, but are not limited to, one or more elements of customer data 206, payment data 208, transaction data 210, and vendor data 212.

By way of example, and based on the elements of field mapping data 138A, executed decomposition engine 146 may determine that RFP message 226 includes data within message fields that identify and characterize user 101, and may perform operations that obtain, from the corresponding message fields of RFP message 226, a name of user 101 and a postal address of user 101. Executed decomposition engine 146 may perform additional operations that package the obtained customer name and the postal address into corresponding portions of customer data 206. Further, and based on the elements of field mapping data 138A, executed decomposition engine 146 may perform operations that identify one or more additional message fields of RFP message 226 includes data within message fields identifying and characterizing the merchant that requests the real-time payment, and that obtain, from the additional message fields of RFP message 226, one or more identifiers of the merchant, such as a merchant name 212A and in some instances, an industrial classification code assigned to the merchant, such as SIC code 218B. Executed decomposition engine 146 may perform additional operations that package merchant name 212A and SIC code 218B into corresponding portions of vendor data 212.

Additionally, and based on the elements of field mapping data 138A, executed decomposition engine 146 may identify one or more further message fields of RFP message 226 include elements of data identifying and characterizing the requested payment, such as, but not limited to, a payment amount of the requested payment, an identifier of an account held by the merchant and available to receive the requested payment (e.g., a tokenized account number, etc.), information identifying an account issued by the financial institution and selected by user 101 to fund requested payment (e.g., a tokenized account number, an expiration data and corresponding card verification code, or a bank routing number, etc.). or a requested payment date. Executed decomposition engine 146 may perform operations that extract the payment amount, the account identifier of the customer and merchant accounts, and the requested payment date from the further message fields, and that package the payment amount, the account identifier of the customer and merchant accounts, and the requested payment date into corresponding portions of payment data 208. Further, and based on the elements of field mapping data 138A, executed decomposition engine 146 may determine that additional, or alternate, message fields of RFP message 226 includes elements of transaction data that specify values of one or more parameters characterizing the initiated purchase transaction. For example, the elements of transaction data may include an identifier of each of the purchased products or services (e.g., a universal product code (UPC), etc.), the subtotal for the purchase transaction, the imposed sales tax, the total purchase price, and a time or date of the initiated purchase transaction. Executed decomposition engine 146 may perform operations that extract the elements of transaction data from the additional, or alternate, message fields, and that package the elements of transaction data into corresponding portions of transaction data 210.

Further, executed decomposition engine 146 may also determine, based on the elements of field mapping data 138A, that one or more message field of RFP message 226 includes structured or unstructured elements of remittance data that characterizes further characterize user 101, the merchant counterparty, the requested, real-time payment, or the initiated purchase transaction, and executed decomposition engine 146 may obtain the structured or unstructured elements of remittance data from RFP message 226 and package the obtained elements of remittance data into corresponding portions of remittance information 214. For example, the elements of structured or unstructured remittance data may include a link (e.g., a short-form or tiny URL, a long-form URL, etc.) to formatted invoice data associated with the requested monthly payment and maintained by merchant computing system 110, and executed decomposition engine 146 may obtain the short- or long-form link from message fields of RFP message 226, and package the short- or long-form link into remittance information 214, e.g., as URL 215.

In some instances, the one or more processors of FI computing system 130 may execute a remittance analysis engine 216, which may perform operations that, based on URL 215 maintained within remittance information 214 of decomposed field data 204, programmatically access elements of formatted invoice data 218 maintained at Merchant computing system 110 of the second financial institution, and that process the accessed elements of formatted invoice data 218 to obtain additional, or alternate, elements of customer data 206, payment data 208, transaction data 210, or vendor data 212. For example, remittance analysis engine 216 may access URL 215 maintained within remittance information 214 (e.g., the short- or long-form URL described herein, etc.), and may process URL 215 and generate a corresponding HTTP request 220 for the elements of formatted invoice data 218 maintained at Merchant computing system 110. Executed remittance analysis engine 216 may also perform operations that cause FI computing system 130 to transmit HTTP request 220 across communications network 120 to Merchant computing system 110.

Merchant computing system 110 may, for example, receive HTTP request 220, and based on portions of HTTP request 220 and linking data 222 (e.g., based on a determined match or correspondence between the portions of HTTP request 220 and linking data 222), Merchant computing system 110 may perform operations that obtain the elements of formatted invoice data 218 from data repository 224, and that transmit the elements of formatted invoice data 218 across communications network 120 to FI computing system 130, e.g., as a response to HTTP request 220. Further, as illustrated in FIG. 2A, executed remittance analysis engine 216 may receive the elements of formatted invoice data 218 from Merchant computing system 110, and may perform any of the exemplary processes described herein to parse the elements of formatted invoice data 218 (e.g., in a received format, such as a PDF or HTML form, or in a transformed or enhanced format, etc.) and obtain, from the parsed elements of formatted invoice data 218, one or more of the additional, or alternate, elements of customer data 206, payment data 208, transaction data 210, or vendor data 212. By way of example, executed remittance analysis engine 216 may apply one or more optical character recognition (OCR) processes or optical word recognition (OWR) processes to the elements of formatted invoice data 218 in PDF form to generate, or obtain, elements of textual content representative of the data that characterize user 101, the merchant counterparty, the initiated purchase transaction, or the requested payment.

By way of example, executed remittance analysis engine 216 may perform operations that detect a presence one or more keywords within the generated elements of textual content (e.g., “quantity,” “subtotal,” “tax,” “total,” etc.), and may extract elements of the textual content associated with these keywords as corresponding ones of the additional, or alternate, elements of customer data 206, payment data 208, transaction data 210, or vendor data 212. In other examples, executed remittance analysis engine 216 may detect a presence of the additional, or alternate, elements of customer data 206, payment data 208, transaction data 210, or vendor data 212 within the generated textual content based on an application of one or more adaptively trained machine learning or artificial intelligence models to portions of the textual content, and examples of these adaptively trained machine learning or artificial intelligence models includes a trained neural network process (e.g., a convolutional neural network, etc.)or a decision-tree process that ingests input datasets composed of all, or selected portions, of the textual content. The disclosed embodiments are, however, not limited to exemplary processes for detecting and extracting one or more of the additional, or alternate, elements of customer data 206, payment data 208, transaction data 210, or vendor data 212 from the generated textual content, and in other instances, executed remittance analysis engine 216 may perform any additional, or alternate, process for identifying one or more of the additional, or alternate, elements of customer data 206, payment data 208, transaction data 210, or vendor data 212 within the textual content derived from the processing of the elements of formatted invoice data 218 in PDF format.

Further, and as described herein, the elements of formatted invoice data 218 may be structured in HTML form, and may include metadata that identify and characterize user 101 (e.g., the customer name, etc.), the merchant counterparty (e.g., the name or other identifier, etc.), the requested payment (e.g., a payment amount, etc.), or the initiated purchase transaction (e.g., an identifier or name or a purchased product o service, etc.). Executed remittance analysis engine 216 may perform operations that detect one or more of the elements of metadata within the elements of formatted invoice data 218, and that obtain, from the elements of metadata, additional, or alternate, elements of customer data 206, payment data 208, transaction data 210, or vendor data 212, as described herein. The disclosed embodiments are, however, not limited to these exemplary processes for detecting and extracting the additional, or alternate, elements of customer data 206, payment data 208, transaction data 210, or vendor data 212 from HTML-formatted receipt data, and in other instances, executed remittance analysis engine 216 may perform any additional, or alternate, process detecting and obtaining data from the elements of formatted invoice data 218 structured in HTML form, including, but not limited to, an application of one or more screen-scraping processes to portions of formatted invoice data 218 structured in HTML form.

In some instances, executed decomposition engine 146 may perform operations that store decomposed field data 204, which includes the element of customer data 206, payment data 208, transaction data 210, vendor data 212, and remittance information 214, within a corresponding portion of data repository 134, e.g., within a data record 225 of RTP data store 142. Further, although not illustrated in FIG. 2A, executed decomposition engine 146 may also perform operations that store all, or a selected portion of, RFP message 226 within data record 225 of RTP data store 142, e.g., in conjunction with decomposed field data 204.

Referring to FIG. 2B, and upon execution by the one or more processors of FI computing system 130, executed analytical engine 148 may perform any of the exemplary processes described herein to generate one or more sector-based metric values associated with each, or a selected subset, of the SIC codes specified by the elements of decomposed field data within RTP data store 142, including the elements of decomposed field data 204, and further, to generate customer-based metric values, and perform comparative pricing and demand analysis, for corresponding ones o the small-business customers of the financial institution, such as user 101. By way of example, executed analytical engine 148 may access the elements of decomposed field data maintained within the data records of RTP data store 142, including the elements of decomposed field data 204 maintained within data record 225, and further, may perform that parse vendor data maintained within each of the accessed elements of decomposed field data (e.g., vendor data 212 of decomposed field data 204) and obtain an industrial classification code, such as a SIC code, associated with the merchant involved in the corresponding purchase transaction (e.g., SIC code 212B within decomposed field data 204). Executed analytical engine 148 may perform operations that sort the elements of decomposed field data maintained within RTP data store 142, including the elements of decomposed field data 204 that include SIC code 212B, in accordance with the obtained SIC codes. For instance, executed analytical engine 148 may group together elements of decomposed field data that are associated with a common SIC code, such as, but not limited to SIC codes associated with lawn care or landscaping, ride-share services, or food-food delivery services.

For each of the obtained SIC codes, executed analytical engine 148 may process the customer, payment, and transaction data maintained within each of the grouped elements of decomposed field data, and may perform operations that compute one or more sector-based metric values indicative of pricing of, or a demand for, certain products or services offered by the merchant associated the corresponding SIC code during a current temporal interval, and additionally or alternatively, during prior temporal intervals. The current and/or prior temporal intervals may, for example, include an hour of a current business day, the current business day, or a current business week, month, or quarter, and magnitude of the current and/or prior temporal intervals may, for example, vary across the identified SIC codes. In some examples, the sector-based metric values for each of the obtained SIC codes may include, but are not limited to, an average transaction amount (e.g., as represented by a requested payment amount, etc.) during the current or prior temporal intervals.

The sector-based metric values may also include more granular assessments of pricing and demand during the current or prior temporal intervals for one or more of the obtained SIC codes, such as, but not limited to, include an average transaction value for certain products or services (e.g., average hourly costs for landscaping a lawn, average fees for shared rides via a corresponding ride-share service, average fees for delivering food via a food delivery service, etc.), an average transaction value within certain geographic regions (e.g., ZIP codes 20005, 20007, and 20037 within Washington, D.C.), or combinations thereof (average unit fees for delivering food in ZIP code 20007). In some instances, executed analytical engine 148 may also perform operations that package each of the obtained SIC code, and each of the corresponding sector-based metric values into an element of sector-based metric data 230. By way of example, as illustrated in FIG. 2B, executed analytical engine 148 may perform any of the exemplary processes described herein to compute one or more sector-based metric values 228 based on the grouped elements of decomposed field data that include SIC code 212B, and to package SIC code 212B and sector-based metric values 228 into corresponding element 229 of sector-based metric data 230. Element 229 may also include, in some instances, one or more metadata tags identifying the current or prior temporal interval, the associated product or service, and/or associated geographic region. Executed analytical engine 148 may perform these exemplary operations to generate an element of sector-based metric data 230 for each additional, or alternate, SIC code and corresponding grouping of elements of decomposed field data.

Further, as illustrated in FIG. 2B, executed analytical engine 148 may access the data records of customer profile data store 140, which identify and characterize customers of the financial institution, and may perform operations that parse the data records to obtain a customer identifier 232 of a small-business customer of the financial institution for comparative pricing and demand analysis, such as, but not limited to, user 101. The selection of the small-business customer may be driven by an express request by that customer (e.g., as generated by mobile banking application 108 executed at client device 102, etc.), or may be triggered by an analysis of one or more financial goals associated with the customer (e.g., as maintained within elements of profile data associated with the selected customer within customer profile data store 140, etc.). Examples of these financial goals may, for example, include saving a certain amount of funds during a temporal interval to cover an expected or unexpected work-related expense (e.g., unexpected vehicle maintenance, anticipated payments for new equipment, etc.) or unexpected or expected expenses unrelated to work (e.g., a planned family vacation or business travel, a family event, etc.).

In some instances, executed analytical engine 148 may obtain a customer identifier (e.g., a customer name, an alphanumeric login credential, etc.) associated with the selected small-business customer from customer profile data store 140, such as customer identifier 232 of user 101, and may performs operations to identify of the elements of decomposed field data within RTP data store 142 that include, or reference, customer identifier 232 of user 101, such as, but not limited to, decomposed field data 204. Based on the elements of vendor data maintained within the identified elements of decomposed field data, executed analytical engine 148 may also determine a SIC code that characterizes the business activities of the selected small-business customer, e.g., a SIC code assigned to user 101.

Executed analytical engine 148 may perform operations that process the corresponding elements of customer, payment data, and transaction data maintained within the identified elements of decomposed field data that include, or reference, customer identifier 232 of user 101, and that generate one or more customer-based metric values 234 that characterize a current pricing of, or a demand for, products or services offered for sale by the selected small-business customer, e.g., user 101. Customer-based metric values 234 may, for example, include an average transaction value (e.g., as represented by a requested payment amount) during a current temporal interval, as described herein. Further, customer-based metric values 234 may also include more granular assessments of pricing and demand during the current temporal interval, and may include an average transaction value for certain products or services (e.g., hourly costs for landscaping a lawn, average fees for shared rides via the ride-sharing service, average fees for delivering food via the food delivery service, etc.), an average transaction value within certain geographic regions (e.g., ZIP code 20007 within Washington, D.C.), or combinations thereof (average unit fees for delivering food in ZIP code 20007). In some instances, executed analytical engine 148 may package customer identifier 232 of user 101 and customer-based metric values 234 into corresponding element 235 of sector-based metric data 236. Element 235 may also include, in some instances, one or more metadata tags identifying the current or prior temporal interval, the associated product or service, and/or associated geographic region.

Further, illustrated in FIG. 2B, executed analytical engine 148 may provide sector-based metric data 230 and customer-based metric data 236 as inputs to predictive engine 150. When executed by the one or more processors of FI computing system 130, executed predictive engine 150 may perform operations that analyze customer-based metric values 234 during the current temporal interval (e.g., as maintained within customer-based metric data 236) and the sector-based metric values during the current and/or prior temporal intervals (e.g., as maintained within the elements of sector-based metric data 230 for corresponding ones of the SIC codes), and that generate elements of targeting data 238 identifying and characterizing one or more determined inferences associated with the pricing or demand for the products or services offered for sale by the selected small-business customer, e.g., user 101. In some examples, each of the one or more determined inferences may include a predicted modification to a particular one of the customer-based metric values 234 that, if implemented by user 101 during a future temporal interval, would render the particular one of the customer-based metric values 234 consistent with a corresponding one of the sector-based metric values during that future temporal interval.

In some instances, executed predictive engine 150 may determine at least one of the pricing- or demand-specific inferences, and predict the modification to the particular one of the customer-based metric values 234, based on an application of one or more internal rules to portions of customer-based metric values 234 and to portions of the sector-based metric values maintained within sector-based metric data 230, e.g., the portion of the sector metric values associated with the SIC code of user 101 and maintained within a corresponding element of sector-based metric data 230 that includes the SIC code of user 101. In other examples, executed predictive engine 150 may perform operations that apply a trained machine learning or artificial intelligence process to an input dataset obtained, or extracted, or derived from portions of customer-based metric values 234 and to portions of the sector-based metric values maintained within sector-based metric data 230 (e.g., the portion of the sector metric values associated with the SIC code of user 101 and maintained within a corresponding element of sector-based metric data 230 that includes the SIC code of user 101), and based on the application of the trained machine learning or artificial intelligence process to the input dataset, executed predictive engine 150 may generate one or more elements of targeting data 238 identify and characterize corresponding ones of the determined inferences (e.g., and the associated predicted modifications to the corresponding ones of the customer-based metric values 234) associated with the pricing or demand for the products or services offered for sale by user 101.

Examples of the trained machine-learning and artificial-intelligence processes may include, but are not limited to, a clustering process, an unsupervised learning process (e.g., a k-means algorithm, a mixture model, a hierarchical clustering algorithm, etc.), a semi-supervised learning process, a supervised learning process, or a statistical process (e.g., a multinomial logistic regression model, etc.). The trained machine-learning and artificial-intelligence processes may also include, among other things, a decision tree process (e.g., a boosted decision tree algorithm, etc.), a random decision forest, an artificial neural network, a deep neural network, or an association-rule process (e.g., an Apriori algorithm, an Eclat algorithm, or an FP-growth algorithm). Further, and as described herein, each of these exemplary machine-learning and artificial-intelligence processes may be trained against, and adaptively improved using, elements of training and validation data, and may be deemed successfully trained and ready for deployment when a value of one or more performance or accuracy metrics are consistent with one or more threshold training or validation criteria.

For instance, the trained machine learning or artificial intelligence process may include a trained decision-tree process, and executed predictive engine 150 may obtain, from one or more tangible, non-transitory memories, elements of process input data and process parameter data associated with the trained decision-tree process (not illustrated in FIG. 2B). For example, the elements of process input data may characterize a composition of the input dataset for the trained decision-tree process and identify each of the discrete data elements within the input data set, along with a sequence or position of these elements within the input data set, and the elements of process parameter data may include a value for one or more parameters of the trained decision-tree process. Examples of these parameter values include, but are not limited to, a learning rate associated with the trained, decision-tree process, a number of discrete decision trees included within the trained, decision-tree process, a tree depth characterizing a depth of each of the discrete decision trees, a minimum number of observations in terminal nodes of the decision trees, and/or values of one or more hyperparameters that reduce potential process overfitting.

In some examples, not illustrated in FIG. 2B, executed predictive engine 150 may perform operations that generate one or more discrete elements (e.g., “feature values”) of the input dataset in accordance with the elements of process input data and based on the portions of customer-based metric values 234 and to portions of the sector-based metric values maintained within sector-based metric data 230 (e.g., the portion of the sector metric values associated with the SIC code of user 101 and maintained within a corresponding element of sector-based metric data 230 that includes the SIC code of user 101). Based on portions of the process parameter data, executed predictive engine 150 may perform operations that establish a plurality of nodes and a plurality of decision trees for the trained decision-tree process, each of which receive, as inputs (e.g., “ingest”), corresponding elements of the input dataset. Further, and the ingestion of the input dataset by the established nodes and decision trees of the trained decision-tree process, executed predictive engine 150 may perform operations that apply the trained, decision-tree process to the input dataset, and that generate one or more of the elements of targeting data 238 that identify and characterize corresponding ones of the determined inferences associated with the pricing or demand for the products or services offered for sale by user 101 (e.g., corresponding ones of the predicted modifications to the customer-based metric values 234).

By way of example, user 101 (e.g., the selected small-business customer) may include a landscaping company that provides landscaping services to retail customers on a per-hour cost basis. Based on an analysis of the portions of customer-based metric values 234 and the portions of the sector-based metric values maintained within sector-based metric data 230 (e.g., the portion of the sector metric values associated with the SIC code of user 101 and maintained within a corresponding element of sector-based metric data 230 that includes the SIC code of user 101), executed predictive engine 150 may perform any of the exemplary processes described herein to determine that the small-business customer's hourly fees are 20% lower than average within a corresponding geographic area. Executed predictive engine 150 may also perform operations that generate one or more elements 240 of targeting data 238 that recommends the small-business customer increase these hourly fees to capitalize on the current demand for landscaping services (e.g., by at least 10%).

Additionally, in some instances, executed predictive engine 150 may implement one or more of the exemplary processes described herein, which generate elements of targeting data 238 that identify and characterize corresponding ones of the determined inferences associated with the pricing or demand for the products or services offered for sale by user 101, in response to or based on one or more financial or budgeting goals associated with user 101 (e.g., as specified within the accessed profile data elements). For example, the accessed elements of customer profile data store 140 associated with user 101 may indicate that user 101 (e.g., the selected small-business customer, such as the landscaping company) plans to acquire new landscaping equipment associated with a $500 initial outlay of funds during the next thirty days. Based on an analysis of the portions of customer-based metric values 234 and the portions of the sector-based metric values maintained within sector-based metric data 230 (e.g., the portion of the sector metric values associated with the SIC code of user 101 and maintained within a corresponding element of sector-based metric data 230 that includes the SIC code of user 101), and on the accessed elements of customer profile data store 140, executed predictive engine 150 may perform any of the exemplary processes described herein to determine that landscaping company should increase its hourly fees, which current lag 20% behind competitor landscaping companies, by at least 15% to capitalize on the increased demand and to fund the expected expenditure. Executed predictive engine 150 may perform operations that package, into elements 240 of targeting data 238, information that identifies the landscaping company's financial goals and the recommended 15% increase in hourly fees to accommodate the financial goals.

Further, in some examples, user 101 may correspond to a driver associated with a ride-sharing service, and based on an analysis of the portions of customer-based metric values 234 and the portions of the sector-based metric values maintained within sector-based metric data 230 (e.g., the portion of the sector metric values associated with the SIC code of user 101 and maintained within a corresponding element of sector-based metric data 230 that includes the SIC code of user 101), executed predictive engine 150 may perform any of the exemplary processes described herein to determine that user 101 often provides ride-sharing services to customers disposed within a particular geographic region (e.g., ZIP code 20037 within Washington, D.C.), to determine that, during a prior thirty-minute period, an average cost of ride-sharing services provided within an adjacent geographic region (e.g., ZIP code 20007 within Washington, D.C.) exceeds the average cost within the particular geographic region by 75%, and to determine that user 101 may now take advantage of “surge pricing” by operating within the adjacent geographic region. Executed predictive engine 150 may perform operations that generate one or more elements 242 of targeting data 238 that recommends user 101 provide shared rides within the adjacent geographic region in an attempt to capture at least a portion of this additional demand.

In additional examples, user 101 may operate as a driver for a food delivery service, and based on an analysis of the portions of customer-based metric values 234 and the portions of the sector-based metric values maintained within sector-based metric data 230 (e.g., the portion of the sector metric values associated with the SIC code of user 101 and maintained within a corresponding element of sector-based metric data 230 that includes the SIC code of user 101), executed predictive engine 150 perform any of the exemplary processes described herein to determine that the current average delivery fee provided to user 101 is consistent with the average delivery fee within a first geographic region (e.g., ZIP code 20001 of Washington, D.C.), but significantly less than an average delivery fee in an adjoining jurisdiction (e.g., ZIP code 22202 of Arlington, Va.). Executed predictive engine 150 may generate additional elements 244 of targeting data 238 that recommend user 101 attempt to capture at least a portion of this additional demand by providing food delivery services within the adjoining geographic region (e.g., ZIP code 22202 of Arlington, Va.).

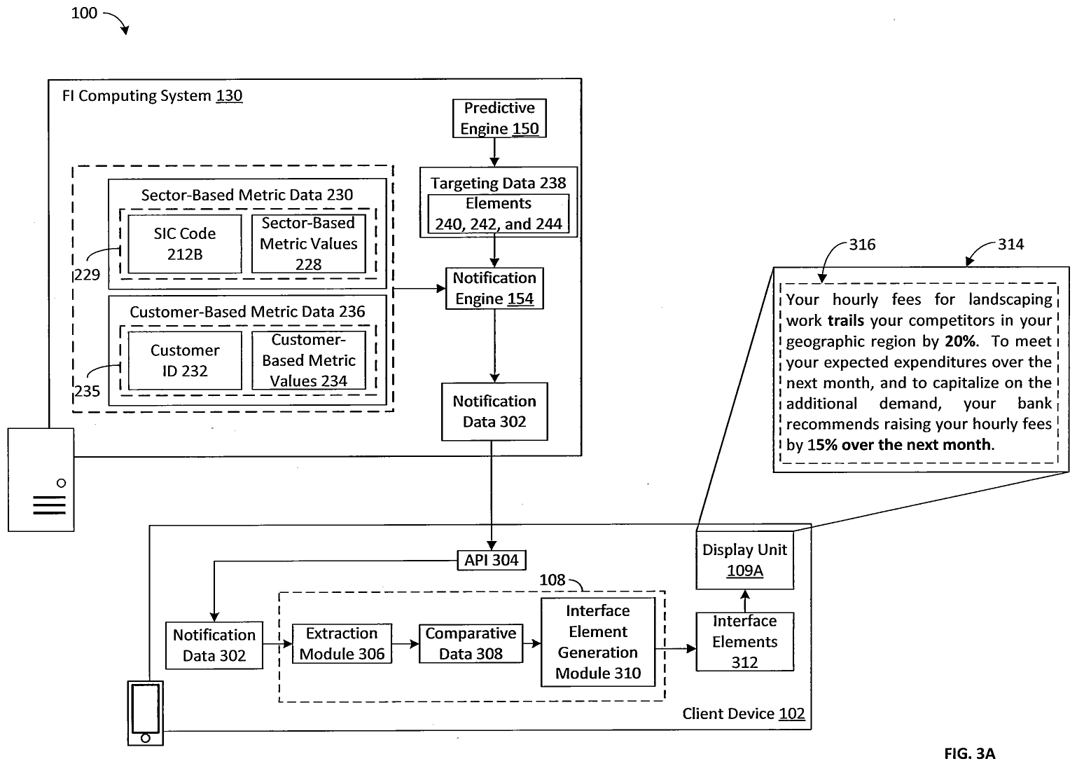

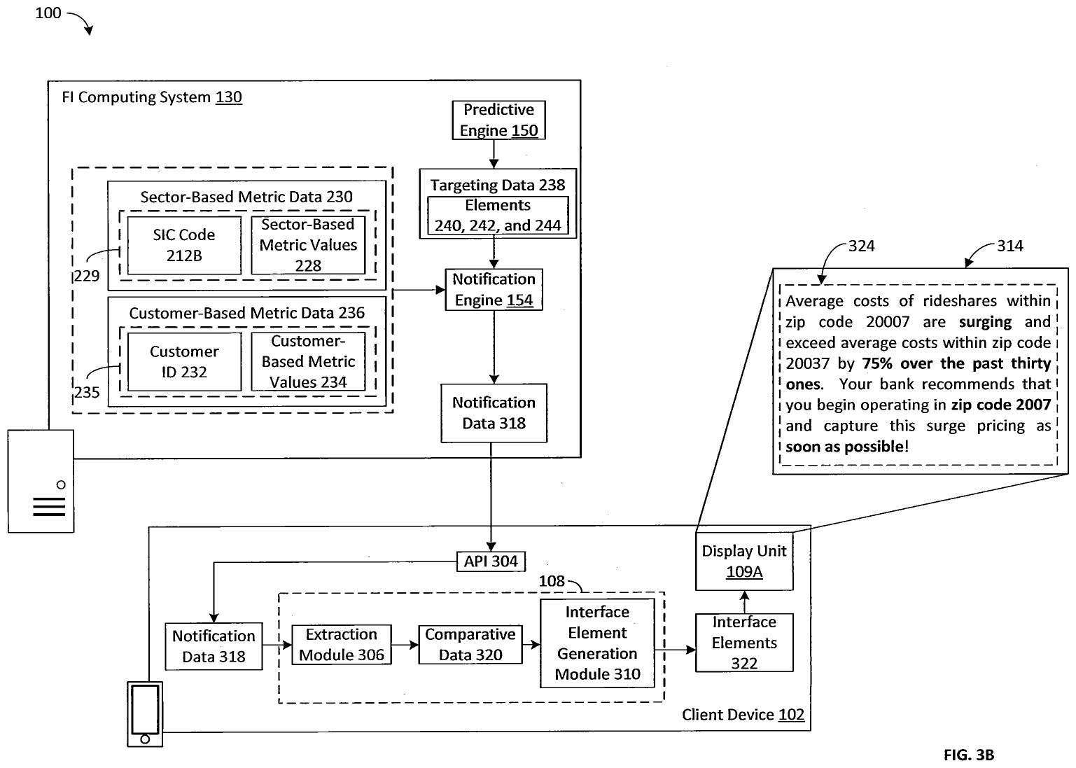

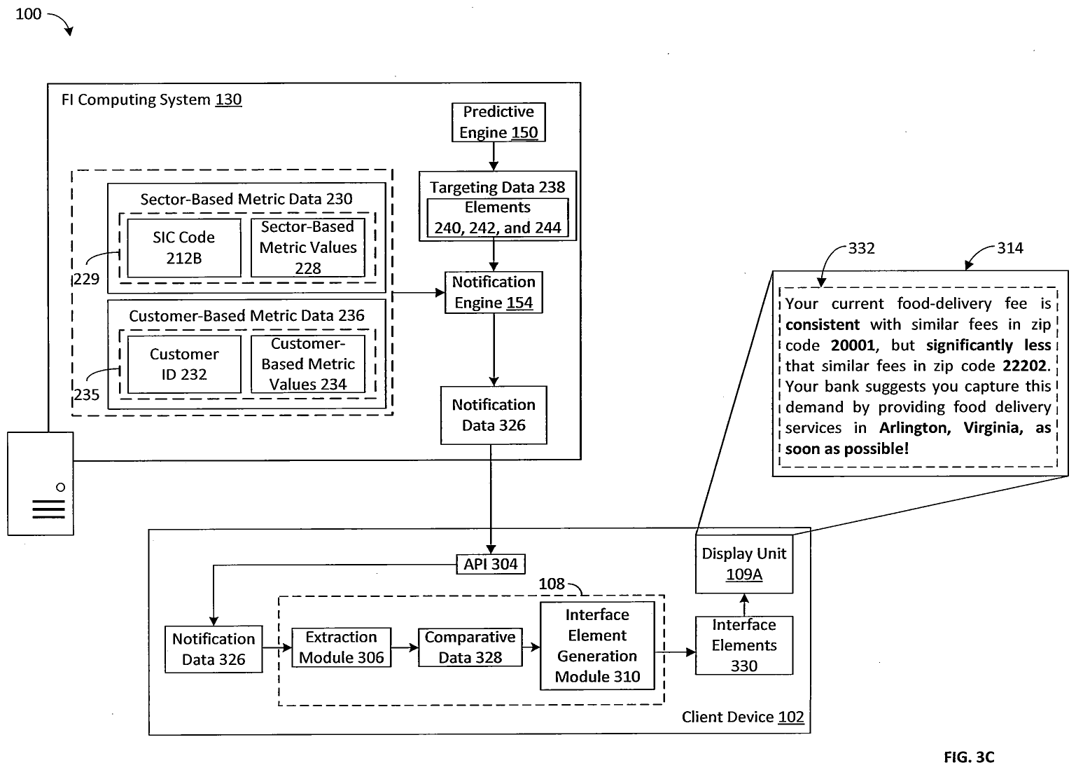

Referring to FIG. 3A, executed predictive engine 150 may provide targeting data 238, including elements 240, 242, and 244, to notification engine 152 executed by the one or more processors of FI computing system 130. In some instances, executed notification engine 152 may perform operations that parse one or more elements of targeting data 238, such as elements 240, and generate corresponding elements of notification data 302 that include, among other things, portions of elements 240 of targeting data 238, portions of customer-based metric values 234 and additionally, or alternatively, to portions of the sector-based metric values maintained within sector-based metric data 230 associated with the SIC code of user 101. By way of example, user 101 may correspond to the landscaping company that provides landscaping services to retail customers on a per-hour cost basis, and as described herein, elements 240 of targeting data 238 may include information that recommends user 101 increase these hourly fees by at least 10% to capitalize on the current demand for landscaping services and further, that recommends user 101 consider increasing increase its hourly fees, which current lag 10% behind competitor landscaping companies, by at least 15% to capitalize on the increased demand and to fund the expected expenditure of $500.

Executed notification engine 152 may perform operations that cause FI computing system 130 to transmit the notification data 302 across communications network 120 to the computing device or system operable by the selected small-business customer, e.g., client device 102 operable by user 101. A programmatic interface associated with one or more application programs executed at client device 102, such as application programming interface (API) 304 associated with mobile banking application 108, may receive notification data 302. Additionally, API 304 may perform operations that cause client device 102 to execute mobile banking application 108 (e.g., through a generation of a programmatic command, etc.). Upon execution by the one or more processors of client device 102, executed mobile banking application 108 may receive notification data 302 from API 304, and an extraction module 306 of executed mobile banking application 108 may parse notification data 302 and generate comparative data 308, which includes, among other things, the portions of customer-based metric values 234, the portions of the sector-based metric values maintained within sector-based metric data 230 associated with the SIC code of user 101, and/or the information indicating that the hourly fees currently lag 10% behind competitor landscaping companies, and recommending that user 101 increase the hourly fees by at least 15% to capitalize on the increased demand and to fund the expected expenditure of $500.

Executed extraction module 306 may provision comparative data 308 as an input to an interface element generation module 310 of executed mobile banking application 108, which may perform operations that generate interface elements 312 based on the comparative data 308 and that provision interface elements 312 to display unit 109A. In some instances, when rendered for presentation within a corresponding notification interface 314 by display unit 109A, interface elements 312 may provide a graphical representation 316 of all or a selected portion of comparative data 308. For example, graphical representation 316 may indicate, to user 101, that the hourly fees charged by user 101 for landscaping services currently lag 20% behind competitor landscaping companies, and may recommend that user 101 increase the hourly fees by at least 15% to capitalize on the increased demand and to fund the expected expenditure of $500.

In further examples, referring to FIG. 3B, executed notification engine 152 may perform operations that parse one or more additional elements of targeting data 238, such as elements 242, and generate corresponding elements of notification data 318 that include, among other things, portions of elements 242 of targeting data 238, portions of customer-based metric values 234 and additionally, or alternatively, to portions of the sector-based metric values maintained within sector-based metric data 230 associated with the SIC code of user 101. By way of example, user 101 may correspond to a driver associated with a ride-sharing service, and as described herein, elements 242 of targeting data 238 may include information that indicates user 101 often provides ride-sharing services to customers disposed within a particular geographic region (e.g., ZIP code 20037 within Washington, D.C.), that, during a prior thirty-minute period, the average cost of ride-sharing services provided within an adjacent geographic region (e.g., ZIP code 20007 within Washington, D.C.) exceeds the average cost within the particular geographic region by 75%, and to recommends user 101 provide shared rides within the adjacent geographic region in an attempt to capture at least a portion of this additional demand and take advantage of “surge pricing.”

Executed notification engine 152 may perform operations that cause FI computing system 130 to transmit the notification data 318 across communications network 120 to client device 102, and API 304 associated with executed mobile banking application 108 may receive notification data 302. Executed mobile banking application 108 may receive notification data 318 from API 304, and executed extraction module 306 may perform any of the exemplary processes described herein to parse notification data 318 and generate comparative data 320, which includes, among other things, the portions of customer-based metric values 234, the portions of the sector-based metric values maintained within sector-based metric data 230 associated with the SIC code of user 101, and/or the information indicating user 101 often provides ride-sharing services to customers disposed within ZIP code 20037 of Washington, D.C., indicating during the prior thirty-minute period, the average cost of ride-sharing services provided within ZIP code 20007 of Washington, D.C. exceeds the average cost within the particular geographic region by 75% during the past thirty minutes, and recommending user 101 provide shared rides within the ZIP code 20007 in an attempt to capture, in real-time, at least a portion of this additional demand and take advantage of “surge pricing.”

Executed extraction module 306 may provision comparative data 320 as an input to executed interface element generation module 310, which may perform operations that generate interface elements 322 based on the comparative data 320 and that provision interface elements 322 to display unit 109A. In some instances, when rendered for presentation within a corresponding notification interface 314 by display unit 109A, interface elements 322 may provide a graphical representation 324 of all or a selected portion of comparative data 320. For example, graphical representation 322 may indicate, to user 101, that, during the prior thirty-minute period, the average cost of ride-sharing services provided within ZIP code 20007 within Washington, D.C., exceeds the average cost within the particular geographic region in which user 101 typically operates by 75%, and may recommend user 101 provide shared rides within the adjacent geographic region in an attempt to capture at least a portion of this additional demand and take advantage of “surge pricing.”

Further, in some examples, and referring to FIG. 3C, executed notification engine 152 may perform operations that parse one or more further elements of targeting data 238, such as elements 244, and generate corresponding elements of notification data 326 that include, among other things, portions of elements 244 of targeting data 238, portions of customer-based metric values 234 and additionally, or alternatively, to portions of the sector-based metric values maintained within sector-based metric data 230 associated with the SIC code of user 101. By way of example, user 101 may operate as a driver for a food delivery service, and as described herein, elements 244 of targeting data 238 may include information that indicates the current average delivery fee provided to user 101 is consistent with the average delivery fee within a first geographic region (e.g., ZIP code 20001 of Washington, D.C.), but significantly less than an average delivery fee in an adjoining jurisdiction (e.g., ZIP code 22202 of Arlington, Va.), and that recommend user 101 attempt to capture at least a portion of this additional demand by providing food delivery services within the adjoining geographic region (e.g., ZIP code 22202 of Arlington, Va.).

Executed notification engine 152 may perform operations that cause FI computing system 130 to transmit the notification data 326 across communications network 120 to client device 102, and API 304 associated with executed mobile banking application 108 may receive notification data 326. Executed mobile banking application 108 may receive notification data 326 from API 304, and executed extraction module 306 may perform any of the exemplary processes described herein to parse notification data 326 and generate comparative data 328, which includes, among other things, the portions of customer-based metric values 234, the portions of the sector-based metric values maintained within sector-based metric data 230 associated with the SIC code of user 101, and/or the information that indicates the current average delivery fee provided to user 101 is consistent with the average delivery fee within ZIP code 20001 of Washington, D.C., but significantly less than an average delivery fee in ZIP code 22202 of Arlington, Va., and that recommend user 101 attempt to capture at least a portion of this additional demand by providing food delivery services within ZIP code 22202 of Arlington, Va.

Executed extraction module 306 may provision comparative data 328 as an input to executed interface element generation module 310, which may perform operations that generate interface elements 330 based on the comparative data 328 and that provision interface elements 330 to display unit 109A. In some instances, when rendered for presentation within a corresponding notification interface 314 by display unit 109A, interface elements 330 may provide a graphical representation 332 of all or a selected portion of comparative data 328. For example, graphical representation 332 may indicate, to user 101, that the current average delivery fee provided to user 101 is consistent with the average delivery fee within ZIP code 20001 of Washington, D.C., but significantly less than an average delivery fee in ZIP code 22202 of Arlington, Va., and that recommend user 101 attempt to capture at least a portion of this additional demand by providing food delivery services within ZIP code 22202 of Arlington, Va.

In some examples, notification interface 314 may represent a “push” notification that, when presented by the executed mobile banking application 108, obscures all, or a portion, of a display screen presented within a digital interface of the mobile banking application 108 executed by the client device 102 of the small-business customer. In other examples, the executed mobile banking application 108 may present the notification interface 314 within a lock screen, a notification center, or a home screen of an operating system executed by the client device 102 of the small-business customer (e.g., as a banner or a pop-up). Additionally, in some examples, the presentation of the notification interface 314 by the executed mobile banking application 108 may also trigger a presentation of an additional audible notification (e.g., a particular sound or element of digital music associated with the mobile banking application) and/or a tactile notification (e.g., vibration, etc.).

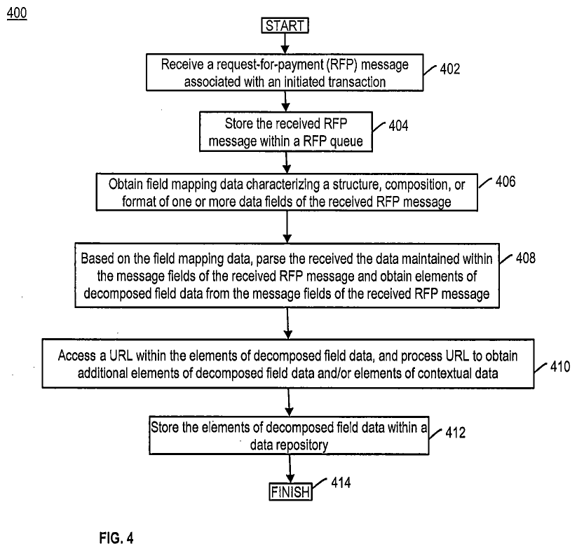

FIG. 4 is a flowchart of exemplary process 400 for decomposing a request-for-payment (RFP) message formatted and structured in accordance with one or more standardized data-exchange protocols, in accordance with some exemplary embodiments. For example, one or more computing systems associated with a financial institution, such as FI computing system 130, may perform one or more of the steps of exemplary process 400. Referring to FIG. 4, FI computing system 130 may perform any of the processes described herein to obtain a RFP message associated with the initiated exchange of data (e.g., in step 402 of FIG. 4). As described herein, the data exchange may include, but is not limited to, a purchase transaction initiated between a first counterparty (e.g., a merchant, such as the merchant associated with merchant computing system 110) and a second counterparty (e.g., a customer of the merchant, such as user 101 associated with client device 102), and the purchase transaction may involve, or be associated with one or more products or services provisioned by the first counterparty to the second counterparty.

The RFP message may be generated by merchant computing system 110 using any of the exemplary processes described herein, and in some instances, FI computing system 130 may receive the RFP message directly from merchant computing system 110 across a corresponding communications network (e.g., communications network 120), or may receive the RFP message from via one or more intermediate computing systems, such as, but not limited to, as a computing system associated with the financial institution of the merchant or one or more computing systems of a clearinghouse associated with the RTP ecosystem. In other instances, the RFP message may be generated by one of intermediate computing systems, such as the computing system associated with the financial institution of the merchant or the one or more computing systems of the clearinghouse, based on elements of data characterizing the purchase transaction and generated by merchant computing system 110.

As described herein, the received RFP message may include message fields consistent with the ISO 20022 standard for electronic data exchange between financial institutions, and each of the message fields may be populated with data structured and formatted in accordance with the ISO 20022 standard. By way of example, the received, ISO-20022-compliant RFP message may include, among other things®i) message fields populated with data specifying a full name and postal address of user 101; (ii) message fields populated with data identifying a payment instrument selected by user 101 to fund the initiated purchase transaction; (iii) message fields populated with data specifying a name and postal address of the merchant; (iv) message fields populated with data identifying a financial services account held by the merchant and available to receive processed from the requested payment; and (v) message fields populated with one or more parameter values that characterize the purchase transaction, a requested payment method, and/or a requested payment date. Further, and as described herein, the received, ISO-20022-compliant RFP message may also include structured or unstructured message fields that specify additional remittance information associated with the purchase transaction, and examples of the additional remittance information include, but are not limited to, information identifying a product or service involved in the purchase transaction, or a link to remittance data associated with the initiated transaction (e.g., a long-form URL or shortened to a PDF or HTML invoice, as described herein).

Referring back to FIG. 4, FI computing system 130 may store the received RFP message within a corresponding portion of locally accessible data repository, such as within RFP message queue 136 of data repository 134 (e.g., in step 404 of FIG. 4), and may obtain, from the locally accessible data repository, one or more elements of field mapping data that characterize a structure, composition, or format of one or more data fields of the received RFP message (e.g., in step 406 of FIG. 4). Based on the obtained elements of the field mapping data, FI computing system 130 may perform any of the exemplary processes described herein to parse the data maintained within the message fields of the received RFP message, and to obtain elements of decomposed field data that identify and characterize user 101, the merchant, the purchase transaction, and the payment requested from user 101 by the merchant for the purchased products or services (e.g., in step 408 of FIG. 4). For example, the elements of decomposed field data (e.g., decomposed field data 204 of FIG. 2A and 2B) may include, but are not limited to, customer data that identifies a full name or address of user 101 (e.g., customer data 206 of decomposed field data 204), payment data that identifies a requested payment date, a requested payment account, a payment instrument selected by user 101 to fund the purchase transaction, or a (e.g., payment data 208 of decomposed field data 204), transaction data that includes a value of one or more parameters of the transaction, such as a total transaction amount, a transaction subtotal or an imposed local tax, or an identifier of one or more of the purchased products or services (e.g., transaction data 210 of decomposed field data 204), and vendor data that includes a name of the merchant, a postal address associated with the merchant, or an industrial classification code, such as an SIC code, associated with or assigned to the merchant (e.g., vendor data 212 of decomposed field data 204).

Further, and as described herein, the elements of decomposed field data may also include additional elements of structured or unstructured remittance data, such as, but not limited to, a long-form URL or a shortened URL that point to elements of formatted invoice data (e.g., in PDF or HTML form) associated with the initiated purchase transaction and maintained at one or more additional computing systems, such as merchant computing system 110 (e.g., URL 215 of remittance information 214 of decomposed field data 204). In some instances, FI computing system 130 may perform any of the exemplary processes described herein to process the long-form URL or a shortened URL and to obtain (i) additional elements of decomposed field data that identify and characterize user 101, the merchant, the initiated purchase transaction, and the payment requested from user 101 by the merchant for the purchased products or services, and/or (ii) elements of contextual data that further characterize user 101, the merchant, the initiated purchase transaction, or the payment requested (e.g., in step 410 of FIG. 4). FI computing system 130 may also perform operations, described herein, that store the additional elements of decomposed field data and/or the elements of contextual data within corresponding portions of the decomposed field data (e.g., portions of customer data 206, payment data 208, transaction data 210, and vendor data 212 of decomposed field data 204).

For example, the long-form URL may include one or more embedded elements of customer data, counterparty data, or transaction data, such as, but not limited to, the postal code of the merchant involved in the initiated purchase transaction and an identifier of the customer. In some instances, FI computing system 130 may perform any of the exemplary processes described herein may parse the long URL to identify and extract one or more of the additional elements of decomposed field data from the long-form URL, and to store the additional elements of decomposed field within the data repository (e.g., in step 410 of FIG. 4). Further, in some examples, FI computing system 130 may perform any of the exemplary processes described herein to process the long- or shortened URL and obtain elements of formatted data associated with the initiated purchase transaction and maintained by a computing system of the merchant, such as formatted invoice data 218 of FIG. 2A (e.g., also in step 410 of FIG. 4).

As described herein, the formatted data may be structured in PDF or HTML format, and FI computing system 130 may perform any of the exemplary processes described herein to may perform operations, described herein to process the elements of formatted data (e.g., through an application of an optical character recognition (OCR) process to the formatted data structured in PDF form, or to parse code associated with, or apply a screen-scraping process to, the formatted data structured in HTML form), and obtain one or more of the additional elements of the decomposed field data and/or the elements of contextual data (e.g., also in step 410 of FIG. 4).

FI computing system 130 may also perform operations, described herein, that store the elements of decomposed field data in a data repository, such as, but not limited to, one or more of the data records of RTP data store 142 of FIG. 1 (e.g., in step 412 of FIG. 4). Exemplary process 400 may then be completed in step 414.

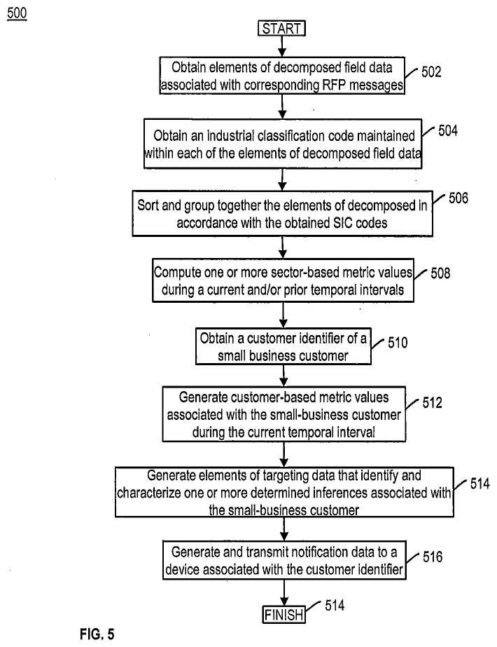

FIG. 5 is a flowchart of an exemplary process 500 for predicting targeted modifications to customer-based metric values during future temporal intervals, in accordance with some exemplary embodiments. For example, one or more computing systems associated with a financial institution, such as FI computing system 130, may perform one or more of the exemplary process 500. Referring to FIG. 5A, FI computing system 130 may perform any of the exemplary processes described herein to obtain one or more elements of decomposed field data associated with corresponding RFP messages (e.g., in step 502 of FIG. 5). By way of example, each of the elements of decomposed field data may be associated with a corresponding request-for-payment (RFP) message formatted and may be structured in accordance with one or more standardized data-exchange protocols, such as the ISO 20022 standard for electronic data exchange between financial institutions. Further, FI computing system 130 may perform any of the exemplary processes described herein to obtain, extract, or derive the elements of decomposed field data from data maintained within the structured or unstructured message fields of the corresponding RFP message.

In step 504 of FIG. 5, FI computing system 130 may also obtain an industrial classification code of a merchant, such as a SIC code, maintained within each of the elements of decomposed field data, e.g., SIC code 212B maintained within vendor data 212 of decomposed field data 204. FI computing system 130 may perform any of the exemplary processes described herein to sort the elements of decomposed in accordance with the obtained SIC codes, and to group together the elements of decomposed field data that are associated with common SIC codes (e.g., in step 506 of FIG. 5). Further, and for each of the common SIC codes, FI computing system 130 may perform any of the exemplary processes described herein to process the customer, payment, and transaction data maintained within each of the corresponding group elements of decomposed field data, and to compute one or more sector-based metric values indicative of pricing of, or a demand for, certain products or services offered by the merchants associated with the corresponding SIC code during a current temporal interval, and additionally or alternatively, during prior temporal intervals (e.g., in step 508 of FIG. 5). The current and/or prior temporal intervals may, for example, include an hour of a current business day, the current business day, or a current business week, month, or quarter, and magnitude of the current and/or prior temporal intervals may, for example, vary across the identified SIC codes.

In some examples, the sector-based metric values for each of the obtained SIC codes may include, but are not limited to, an average transaction amount (e.g., as represented by a requested payment amount, etc.) during the current or prior temporal intervals. The sector-based metric values may also include more granular assessments of pricing and demand during the current or prior temporal intervals for one or more of the obtained SIC codes, such as, but not limited to, including an average transaction value for certain products or services, an average transaction value within certain geographic regions, or combinations thereof. As described herein, FI computing system 130 may also perform operations that package each of the obtained SIC codes, and each of the corresponding sector-based metric values into an element of sector-based metric data, along with one or more metadata tags identifying the current or prior temporal interval, the associated product or service, and/or associated geographic region (e.g., also in step 508 of FIG. 5).

FI computing system 130 may also perform operations, described herein, to obtain a customer identifier of a small business customer of the financial institution (e.g., in step 510 of FIG. 5), and may perform any of the exemplary processes described herein to identify a subset of the elements of decomposed field data include, or reference, the customer identifier, and to process the customer, payment data, and transaction data maintained within the identified subset of the elements of decomposed field data and that generate one or more customer-based metric values that characterize a current pricing of, or a demand for, products or services offered for sale by the small-business customer (e.g., in step 512 of FIG. 5). As described herein, the customer-based metric values may, for example, include an average transaction value (e.g., as represented by a requested payment amount) during a current temporal interval, and additionally, or alternatively, more granular assessments of pricing and demand during the current temporal interval, such as, but not limited to, an average transaction value for certain products or services, an average transaction value within certain geographic regions, or combinations thereof.

In some instances, FI computing system 130 may package the customer identifier and the customer-based metric values into a corresponding element of sector-based metric data, along with one or more metadata tags identifying the current or prior temporal interval, the associated product or service, and/or associated geographic region.

In some examples, FI computing system 130 may also perform any of the exemplary processes described herein to analyze the customer-based metric values during the current temporal interval and the sector-based metric values during the current or prior temporal intervals, and to generate elements of targeting data that identify and characterize one or more determined inferences associated with the pricing or demand for the products or services offered for sale by the small-business customer (e.g., in step 514 of FIG. 5). As described herein, each of the one or more determined inferences may include a predicted modification to a particular one of the customer-based metric values that, if implemented by small business customer during a future temporal interval, would render the particular one of the customer-based metric values consistent with a corresponding one of the sector-based metric values during that future temporal interval.

FI computing system 130 may also perform any of the exemplary processes described to generate an element of notification data based on, associated with one or more of the elements of targeting data, and to transmit the generated elements of notification data to a computing system or device operable by the small business customer (e.g., in step 516 of FIG. 5). Each of the elements of notification data may identify and characterize a corresponding one of the determined inferences, and as such, a corresponding one of the predicted modifications to the customer-based metric values, and upon receipt by the device of the small business customer, one or more executed application programs may process the elements of notification data and present a corresponding, graphical representation of one or more of the determined inferences and the corresponding ones of the predicted modifications to the customer-based metric values. Exemplary process 500 may then be complete in step 518.

### C. Exemplary Hardware and Software Implementations

Embodiments of the subject matter and the functional operations described in this disclosure can be implemented in digital electronic circuitry, in tangibly-embodied computer software or firmware, in computer hardware, including the structures disclosed in this specification and their structural equivalents, or in combinations of one or more of them. Embodiments of the subject matter described in this disclosure, including decomposition engine 146, analytical engine 148, predictive engine 150, notification engine 154, API 202, remittance analysis engine 216, API 304, extraction module 306, and interface element generation module 310 can be implemented as one or more computer programs, i.e., one or more modules of computer program instructions encoded on a tangible non-transitory program carrier for execution by, or to control the operation of, a data processing apparatus (or a computing system). Additionally, or alternatively, the program instructions can be encoded on an artificially-generated propagated signal, such as a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The terms “apparatus,” “device,” and “system” refer to data processing hardware and encompass all kinds of apparatus, devices, and machines for processing data, including by way of example a programmable processor, a computer, or multiple processors or computers. The apparatus, device, or system can also be or further include special purpose logic circuitry, such as an FPGA (field programmable gate array) or an ASIC (application-specific integrated circuit). The apparatus, device, or system can optionally include, in addition to hardware, code that creates an execution environment for computer programs, such as code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, such as one or more scripts stored in a markup language document, in a single file dedicated to the program in question, or in multiple coordinated files, such as files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, such as an FPGA (field programmable gate array) or an ASIC (application-specific integrated circuit).

Computers suitable for the execution of a computer program include, by way of example, general or special purpose microprocessors or both, or any other kind of central processing unit. Generally, a central processing unit will receive instructions and data from a read-only memory or a random-access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, such as magnetic, magneto-optical disks, or optical disks. However, a computer need not have such devices. Moreover, a computer can be embedded in another device, such as a mobile telephone, a personal digital assistant (PDA), a mobile audio or video player, a game console, a Global Positioning System (GPS) or an assisted Global Positioning System (AGPS) receiver, or a portable storage device, such as a universal serial bus (USB) flash drive, to name just a few.

Computer-readable media suitable for storing computer program instructions and data include all forms of non-volatile memory, media and memory devices, including by way of example semiconductor memory devices, such as EPROM, EEPROM, and flash memory devices; magnetic disks, such as internal hard disks or removable disks; magneto-optical disks; and CD-ROM and DVD-ROM disks. The processor and the memory can be supplemented by, or incorporated in, special purpose logic circuitry.

To provide for interaction with a user, such as user of client device 102, embodiments of the subject matter described in this specification can be implemented on a computer having a display device, such as a CRT (cathode ray tube) or LCD (liquid crystal display) monitor, for displaying information to the user and a keyboard and a pointing device, such as a mouse or a trackball, by which the user can provide input to the computer. Other kinds of devices can be used to provide for interaction with a user as well; for example, feedback provided to the user can be any form of sensory feedback, such as visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Implementations of the subject matter described in this specification can be implemented in a computing system that includes a back-end component, such as a data server, or that includes a middleware component, such as an application server, or that includes a front-end component, such as a client computer having a graphical user interface or a Web browser through which a user can interact with an implementation of the subject matter described in this specification, or any combination of one or more such back-end, middleware, or front-end components. The components of the system can be interconnected by any form or medium of digital data communication, such as a communication network. Examples of communication networks include a local area network (LAN) and a wide area network (WAN), such as the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, such as an HTML page, to a user device, such as for purposes of displaying data to and receiving user input from a user interacting with the user device, which acts as a client. Data generated at the user device, such as a result of the user interaction, can be received from the user device at the server.

While this specification includes many specifics, these should not be construed as limitations on the scope of the disclosure or of what may be claimed, but rather as descriptions of features specific to particular embodiments of the disclosure. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Various embodiments have been described herein with reference to the accompanying drawings. It will, however, be evident that various modifications and changes may be made thereto, and additional embodiments may be implemented, without departing from the broader scope of the disclosed embodiments as set forth in the claims that follow.

Further, unless otherwise specifically defined herein, all terms are to be given their broadest possible interpretation including meanings implied from the specification as well as meanings understood by those skilled in the art and/or as defined in dictionaries, treatises, etc. It is also noted that, as used in the specification and the appended claims, the singular forms “a,” “an,” and “the” include plural referents unless otherwise specified, and that the terms “comprises” and/or “comprising,” when used in this specification, specify the presence or addition of one or more other features, aspects, steps, operations, elements, components, and/or groups thereof. Moreover, the terms “couple,” “coupled,” “operatively coupled,” “operatively connected,” and the like should be broadly understood to refer to connecting devices or components together either mechanically, electrically, wired, wirelessly, or otherwise, such that the connection allows the pertinent devices or components to operate (e.g., communicate) with each other as intended by virtue of that relationship. In this disclosure, the use of “or” means “and/or” unless stated otherwise. Furthermore, the use of the term “including,” as well as other forms such as “includes” and “included,” is not limiting. In addition, terms such as “element” or “component” encompass both elements and components comprising one unit, and elements and components that comprise more than one subunit, unless specifically stated otherwise. Additionally, the section headings used herein are for organizational purposes only and are not to be construed as limiting the described subject matter.

The foregoing is provided for purposes of illustrating, explaining, and describing embodiments of this disclosure. Modifications and adaptations to the embodiments will be apparent to those skilled in the art and may be made without departing from the scope or spirit of the disclosure.

What is claimed is:

1. An apparatus comprising:
a communications interface;
a memory storing instructions; and
at least one processor coupled to the communications interface and to the memory, the at least one processor being configured to execute the instructions to:
obtain (i) first elements of decomposed message data that characterize real-time payments requested by a first counterparty and (ii) a second elements of decomposed message data that characterize real-time payments requested by one or more second counterparties, each of the one or more second counterparties being associated with the first counterparty;
determine a first value of a parameter of an exchange of data based on the first elements of decomposed message data, and determine a second value of the parameter based on the second elements of decomposed message data;
based on the first and second parameter values, generate information characterizing a modification to at least the first parameter value during a temporal interval, and transmit, via the communications interface, notification data that includes the information characterizing the modification to a device operable by the first counterparty, the notification data causing an application program executed at the device to present a graphical representation of the modification within a digital interface.

2. The apparatus of claim 1, wherein the at least one processor is further configured to execute the instructions to obtain portions of at least one of the first elements of decomposed message data or the second elements of decomposed message data from the memory.

3. The apparatus of claim 1, wherein the at least one processor is further configured to execute the instructions to:
determine an identifier of the first counterparty, and obtain the first elements of decomposed message data based on the identifier of the first counterparty;
based on the first elements of decomposed message data, determine a classification code that characterizes the first and second counterparties; and
obtain the second elements of decomposed message data based on the classification code.

4. The apparatus of claim 3, wherein the classification code comprises a standard industrial classification (SIC) code, and the SIC code characterizes the first and second counterparties.

5. The apparatus of claim 1, wherein:
the parameter comprises a geographic parameter associated with the exchange of data;
the first parameter value comprises geographic data, the geographic data identifying a first geographic region; and
the information characterizing the modification to at least the first parameter value identifies a second geographic region.

6. The apparatus of claim 1, wherein:
the parameter comprises a transaction parameter of the exchange of data;
the modification comprises an increase in the determined first value of the transaction parameter during the temporal interval.

7. The apparatus of claim 1, wherein the at least one processor is further configured to execute the instructions to apply a trained machine learning or artificial intelligence process to an input dataset that includes at least the first parameter value and the second parameter value, and based on the application of the trained machine learning or artificial intelligence process to the input dataset, generate the information characterizing the modification to the first parameter value.

8. The apparatus of claim 1, wherein the first and second elements of decomposed message data are associated with corresponding exchanges of data initiated during the temporal interval.

9. The apparatus of claim 1, wherein the at least one processor is further configured to execute the instructions to:
receive, via the communications interface, a message associated with an additional exchange of data involving at least one of the first or second counterparties, the message comprising elements of message data disposed within corresponding message fields, and the message data characterizing a real-time payment requested by the at least one of the first or second counterparties;
obtain, from the memory, mapping data associated with the message fields of the message;
perform operations that obtain additional elements of the decomposed message data from corresponding ones of the message fields based on the mapping data; and
store the elements of the message data within the memory.

10. The apparatus of claim 9, wherein:
the message comprises a request-for-payment message, the message fields of the request-for-payment message being structured in accordance with a standardized data-exchange protocol; and
elements of the mapping data identify corresponding ones of the elements of the message data and corresponding ones of the message fields.

11. A computer-implemented method, comprising:
using at least one processor, obtaining (i) first elements of decomposed message data that characterize real-time payments requested by a first counterparty and (ii) a second elements of decomposed message data that characterize real-time payments requested by one or more second counterparties, each of the one or more second counterparties being associated with the first counterparty;
determining, using the at least one processor, a first value of a parameter of an exchange of data based on the first elements of decomposed message data, and determining, using the at least one processor, a second value of the parameter based on the second elements of decomposed message data;
based on the first and second parameter values, generating, using the at least one processor, information that characterizes a modification to at least the first parameter value during a temporal interval, and transmitting, using the at least one processor, notification data that includes the information characterizing the modification to a device operable by the first counterparty, the notification data causing an application program executed at the device to present a graphical representation of the modification within a digital interface.

12. The computer-implemented method of claim 11, wherein:
the first and second elements of decomposed message data are associated with corresponding exchanges of data initiated during the temporal interval; and
the obtaining comprises obtaining portions of at least one of the first elements of decomposed message data or the second elements of decomposed message data from a data repository.

13. The computer-implemented method of claim 11, wherein:
the computer-implemented method further comprises, using the at least one processor, determining an identifier of the first counterparty and determining a classification code that characterizes the first and second counterparties based on the first elements of decomposed message data; and
the obtaining comprises obtaining the first elements of decomposed message data based on the identifier of the first counterparty, and obtaining the second elements of decomposed message data based on the classification code.

14. The computer-implemented method of claim 13, wherein the classification code comprises a standard industrial classification (SIC) code, and the SIC code characterizes the first and second counterparties.

15. The computer-implemented method of claim 11, wherein:
the parameter comprises a geographic parameter associated with the exchange of data;
the first parameter value comprises geographic data, the geographic data identifying a first geographic region; and
the information characterizing the modification to at least the first parameter value identifies a second geographic region.

16. The computer-implemented method of claim 11, wherein:
the parameter comprises a transaction parameter of the exchange of data;
the modification comprises an increase in the first value of the transaction parameter during the temporal interval.

17. The computer-implemented method of claim 11, wherein the generating comprises applying a trained machine learning or artificial intelligence process to an input dataset that includes at least the first parameter value and the second parameter value, and based on the application of the trained machine learning or artificial intelligence process to the input dataset, generating the information characterizing the modification to the first parameter value.

18. The computer-implemented method of claim 11, further comprising:
receiving, using the at least one processor, a message associated with an additional exchange of data involving at least one of the first or second counterparties, the message comprising elements of message data disposed within corresponding message fields, and the message data characterizing an additional real-time payment requested by the at least one of the first or second counterparties;
obtain, using the at least one processor, mapping data associated with the message fields of the message;
performing operations, using the at least one processor, that obtain additional elements of the decomposed message data from corresponding ones of the message fields based on the mapping data; and
storing the elements of the message data within a data repository using the at least one processor.

19. The computer-implemented method of claim 18, wherein:
the message comprises a request-for-payment message, the message fields of the request-for-payment message being structured in accordance with a standardized data-exchange protocol; and
elements of the mapping data identify corresponding ones of the elements of the message data and corresponding ones of the message fields.

20. A tangible, non-transitory computer-readable medium storing instructions that, when executed by at least one processor, cause the at least one processor to perform a method, comprising:
obtaining (i) first elements of decomposed message data that characterize real-time payments requested by a first counterparty and (ii) a second elements of decomposed message data that characterize real-time payments requested by one or more second counterparties, each of the one or more second counterparties being associated with the first counterparty;
determining a first value of a parameter of an exchange of data based on the first elements of decomposed message data, and determining a second value of the parameter based on the second elements of decomposed message data;
based on the first and second parameter values, generating information that characterizes a modification to at least the first parameter value during a temporal interval, and transmitting notification data that includes the information characterizing the modification to a device operable by the first counterparty, the notification data causing an application program executed at the device to present a graphical representation of the modification within a digital interface.
